(19) United States
(12) Patent Application Publication
(10) Pub. No.: US 2026/0135795 A1
(43) Pub. Date: May 14, 2026

(54) METHOD AND APPARATUS FOR PATH SELECTION IN A COMMUNICATION NETWORK

(71) Applicant: Marvell Asia Pte Ltd, Singapore (SG)

(72) Inventors: Puneet AGARWAL, Santa Clara, CA (US); Rupa BUDHIA, San Jose, CA (US); William Brad MATTHEWS, Los Gatos, CA (US)

(21) Appl. No.: 18/731,122

(22) Filed: May 31, 2024

Related U.S. Application Data
(60) Provisional application No. 63/528,858, filed on Jul. 25, 2023.

(51) Int. Cl. H04L 45/121; H04L 45/24; H04L 45/745; H04L 47/125

(52) U.S. Cl. CPC H04L 45/121; H04L 45/24; H04L 45/745; H04L 47/125

(57) ABSTRACT

A first network device determines a set of one or more first paths through the network switching system for forwarding a packet to a second network device in the network switching system, including determining the set of one or more first paths from amongst minimal paths through the network switching system. The first network device determines a set of one or more second paths through the network switching system for forwarding the packet to the second network device, including determining the set of one or more second paths from amongst non-minimal paths through the network switching system. The first network device selects one of the set of one or more first paths, and the set of one or more second paths for forwarding the packet through the network switching system, including sometimes selecting the set of one or more second paths for forwarding the packet through the network switching system.

### CROSS REFERENCES TO RELATED APPLICATIONS

This application claims the benefit of U.S. Provisional Patent App. No. 63/528,858, entitled “Adaptive Routing with Dynamic Probabilistic Path Selection,” filed on Jul. 25, 2023, the disclosure of which is expressly incorporated herein by reference in its entirety.

### FIELD OF TECHNOLOGY

The present disclosure relates generally to communication networks, and more particularly to path selection in a communication network.

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

Some networking applications require switching between a very large number of ports. For example, a typical data center includes a large number of servers, and switches to interconnect the servers and to communicatively couple the servers to outside network connections, such as backbone network links. In such applications, switching systems capable of switching between numerous ports are utilized so that traffic can be forwarded between servers and/or between servers and backbone network lines. Such switching systems can include a large number of switches, and each switch typically is capable of switching between several ports. In data centers and server farms, multiple layers of switches are often utilized, where a first layer of switches interconnects a second layer of switches, where the second layer of switches are connected to servers, storage devices, backbone network lines, etc. Some applications also include one or more additional layers of switches that interconnect switches from the first layer of switches.

Communication networks such as described above typically provide multiple alternative network paths between pairs of network devices so that, if a communication link in a path fails, for example, data can be redirected over an alternative path. Additionally, packets can be spread across multiple alternative paths for load balancing. It is often important to balance traffic load among multiple alternative paths to reduce latency through the communication network.

### SUMMARY

In an embodiment, a network device that selects paths through a network switching system comprises: a packet processor configured to: determine a set of one or more first paths through the network switching system for forwarding a packet to a second network device in the network switching system, including determining the set of one or more first paths from amongst minimal paths through the network switching system, and determine a set of one or more second paths through the network switching system for forwarding the packet to the second network device, including determining the set of one or more second paths from amongst non-minimal paths through the network switching system. The packet processor includes a path selection engine configure to select one of i) the set of one or more first paths, and ii) the set of one or more second paths for forwarding the packet through the network switching system, including sometimes selecting the set of one or more second paths for forwarding the packet through the network switching system.

In another embodiment, a method for selecting paths through a network switching system includes: determining, at a first network device, a set of one or more first paths through the network switching system for forwarding a packet to a second network device in the network switching system, including determining the set of one or more first paths from amongst minimal paths through the network switching system; determining, at the first network device, a set of one or more second paths through the network switching system for forwarding the packet to the second network device, including determining the set of one or more second paths from amongst non-minimal paths through the network switching system; and selecting, at the first network device, one of i) the set of one or more first paths, and ii) the set of one or more second paths for forwarding the packet through the network switching system, including sometimes selecting the set of one or more second paths for forwarding the packet through the network switching system.

### BRIEF DESCRIPTION OF THE DRAWINGS

FIG. 1A is a simplified block diagram of an example network switching system in which network devices sometimes select non-minimal paths through the network switching system, according to an embodiment.

FIG. 1B is a simplified block diagram of the network switching system of FIG. 1A highlighting minimal paths through the network switching system, according to an embodiment.

FIG. 1C is a simplified block diagram of the network switching system of FIG. 1A highlighting subminimal paths through the network switching system, according to an embodiment.

FIG. 2 is a simplified block diagram of an example network device of the network switching system of FIG. 1, according to an embodiment.

FIG. 3 is a flow diagram of an example method for selecting a path through a network switching system for a packet performed by a network device of the network switching system of FIG. 1A, according to an embodiment.

FIG. 4A is a flow diagram of another example method for selecting a path through a network switching system for a packet performed by a network device of the network switching system of FIG. 1A, according to another embodiment.

FIG. 4B is a flow diagram of another example method for selecting a path through a network switching system for a packet performed by a network device of the network switching system of FIG. 1A, according to another embodiment.

FIG. 5 is a flow diagram of another example method for selecting a path through a network switching system for a packet performed by a network device of the network switching system of FIG. 1A, according to another embodiment.

FIG. 6A is a plot of an example probability distribution function used by a network device of the network switching system of FIG. 1A to select paths through a network switching system, according to an embodiment.

FIG. 6B is a plot of another example probability distribution function used by a network device of the network switching system of FIG. 1A to select paths through a network switching system, according to an embodiment.

FIG. 7 is a simplified block diagram of an example network device of the network switching system of FIG. 1, according to an embodiment.

FIG. 8 is a flow diagram of an example method for selecting a link in a network switching system for transmitting a packet performed by a network device of the network switching system of FIG. 1A, according to an embodiment.

FIG. 9A is a flow diagram of another example method for selecting a link in a network switching system for transmitting a packet performed by a network device of the network switching system of FIG. 1A, according to another embodiment.

FIG. 9B is a flow diagram of another example method for selecting a link in a network switching system for transmitting a packet performed by a network device of the network switching system of FIG. 1A, according to another embodiment.

FIG. 10 is a flow diagram of an example method, performed by a network device of the network switching system of FIG. 1A, for selecting a path and/or link through the network switching system for a packet that belongs to a flow or flowlet for which a path/link was previously selected, according to an embodiment.

FIG. 11 is a plot of an example probability distribution function used by a network device of the network switching system of FIG. 1A to probabilistically select between one of i) determining that a current path/link should be used (i.e., a new path/link should not be used), and ii) determining that a new path/link is to be selected, according to an embodiment.

### DETAILED DESCRIPTION

Embodiments described herein provide improved techniques for selecting paths through a network switching system. For instance, in connection with selecting a path through the network switching system for a packet, a network device selects one of i) a set of one or more minimal paths, and ii) a set of one or more non-minimal paths, in an embodiment. In this context, minimal path is a path having a shortest length in terms of hops, i.e., a minimal number of hops between endpoints; a non-minimal path is a path having a length in terms of hops that is greater than the shortest length of the network switching system, i.e., a number of hops between endpoints that is greater than the minimal number of hops between the endpoints. In embodiments such as described above, a non-minimal path is sometimes chosen for packets, which provides advantages over prior art load balancing techniques. For instance, always selecting minimal paths may lead to a flooding of packets to previously uncongested minimal paths, which leads to these minimal paths quickly becoming congested, whereas sometimes selecting non-minimal paths such as described above mitigates such flooding, at least in some embodiments. In some embodiments, the selection between i) the set of one or more minimal paths, and ii) the set of one or more non-minimal paths is performed probabilistically. In some embodiments, the selection between i) the set of one or more minimal paths, and ii) the set of one or more non-minimal paths is performed according to a probability that favors selecting the set of one or more minimal paths, at least in some situations. In some embodiments, the selection between i) the set of one or more minimal paths, and ii) the set of one or more non-minimal paths is performed in a deterministic manner in which the set of one or more minimal paths is sometimes selected, and the set of one or more non-minimal paths is sometimes selected.

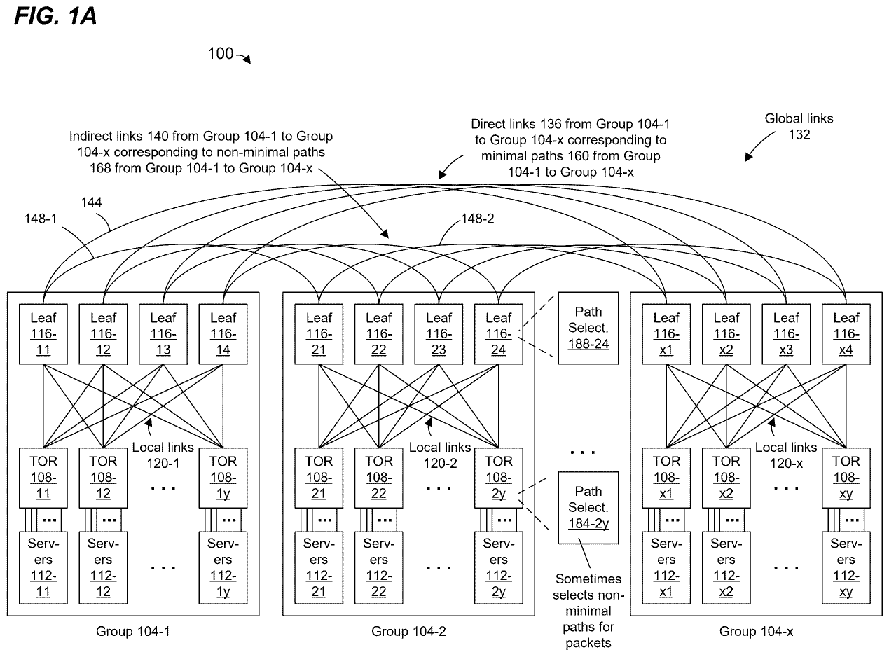

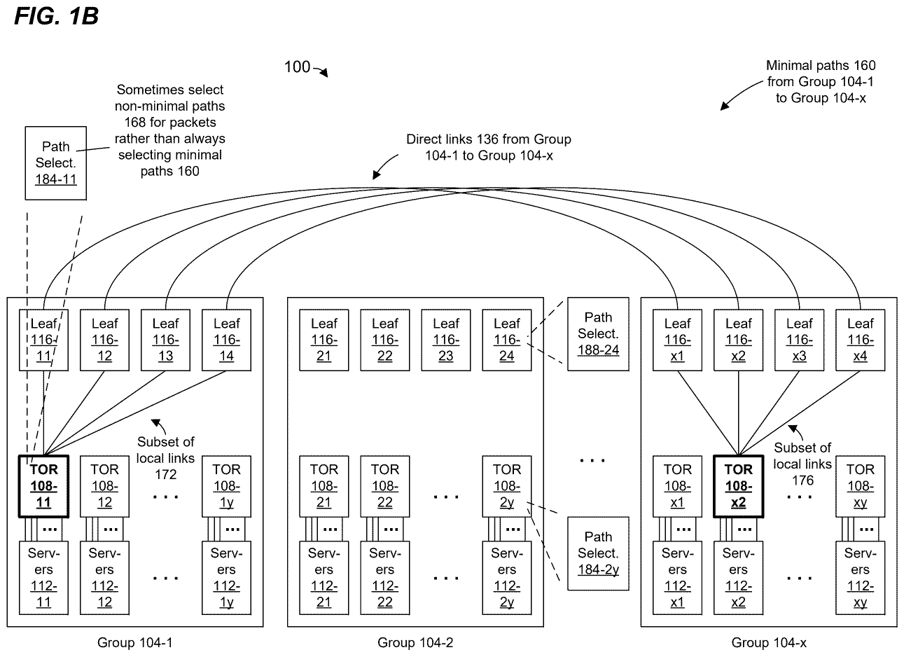

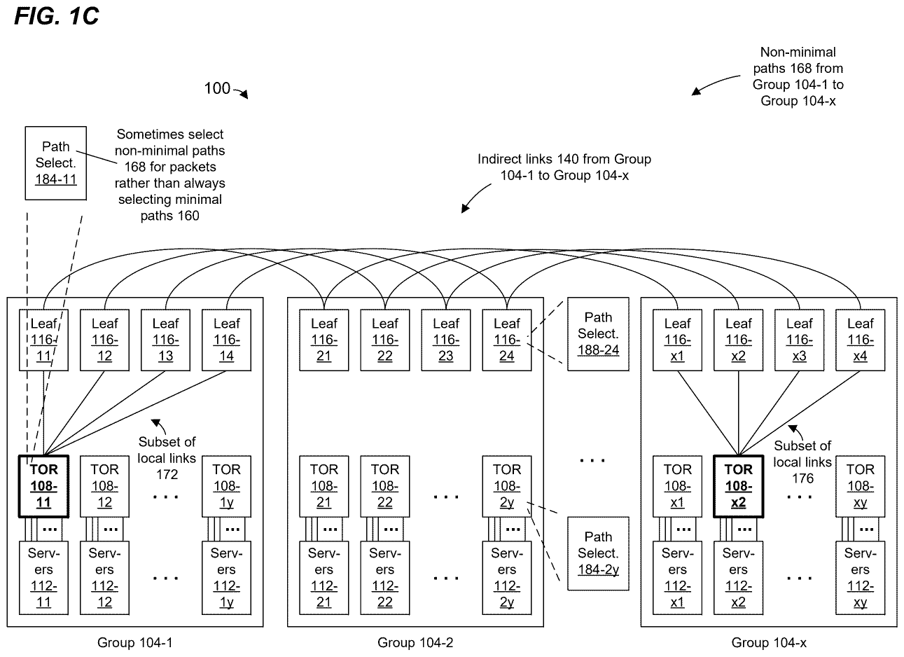

FIG. 1A is a simplified diagram of an example communication network 100, according to an embodiment. The communication network 100 has a network topology sometimes referred to as a dragonfly+topology. In other embodiments, the communication network 100 has another suitable network topology, such as a dragonfly topology, a clos topology, a fat tree topology, etc.

The communication network 100 includes a plurality of groups 104. Each group 104 includes a plurality of switches 108, where each switch 108 is coupled to a respective group of servers 112. For example, each switch 108 includes a plurality of ports (not shown in FIG. 1A), sometimes referred to herein as “downlink ports” that are respectively connected to servers 112 via network links. In some embodiments, each of at least some servers 112 is connected to a respective switch 108 via one or more network links.

Although each switch 108 is shown in FIG. 1A as being coupled to a respective group of servers 112, each group 112 optionally includes one or more other network devices in addition to or instead of servers, such as storage devices, in some embodiments. Additionally, each of at least some of the switches 108 optionally includes one or more downlink ports connected to one or more backbone network links, in some embodiments. The network links that couple servers 112 (and/or other suitable network devices) to downlink ports of the switch 108 comprise suitable communication media such as electrical cables (e.g., twisted pair cables, coaxial cables, etc.), optical cables, etc.

The switches 108 are sometimes referred to herein as “top of rack” or TOR switches because at least some of the switches 108 are mounted in a top rack of a server rack, with corresponding servers 112 mounted in racks below the top rack. In other embodiments, at least some of the switches 108 are mounted in any suitable rack of a server rack, or are not mounted in a server rack at all. Similarly, at least some of the servers 112 corresponding to a switch 108 are separately housed from the switch 108 (e.g., the at least some servers 112 and the corresponding switch 108 are not mounted in a same server rack), in some embodiments.

Each group 104 also includes a plurality of switches 116 (sometimes referred to herein as “leaf switches” to distinguish from the TOR switches), where each TOR switch 108 is coupled to multiple leaf switches 116. For example, each leaf switch 116 includes a plurality of ports (not shown in FIG. 1A), sometimes referred to herein as “downlink ports” that are respectively connected to TOR switches 108 via network links 120. The network links 120 comprise suitable communication media such as metallic cables (e.g., twisted pair cables, coaxial cables, etc.), optical cables, etc. In some embodiments, each of at least some TOR switch 108/leaf switch 116 pairs is connected via more than one network link 120 (e.g., more than one cable). Each TOR switch 108 includes a plurality of ports (sometimes referred to herein as “uplink ports”) that are connected to the downlink ports of the leaf switches 116 via the network links 120. The network links 120 are sometimes referred to herein as “local links.”

Each leaf switch 116 also includes a plurality of ports (not shown in FIG. 1A), sometimes referred to herein as “uplink ports” that are respectively connected to leaf switches 116 of other groups 104 via network links 132, sometimes referred to herein as “global links.” The global links 132 comprise suitable communication media such as metallic cables (e.g., twisted pair cables, coaxial cables, etc.), optical cables, etc. In some embodiments, each of at least some leaf switch 116 pairs is connected via more than one global link 132 (e.g., more than one cable).

In some embodiments, each of at least some groups 104 includes more TOR switches 108 than leaf switches 116. In other embodiments, each of at least some groups 104 includes more leaf switches 116 than TOR switches 108. For each of at least some of the groups 104, the number of global links 132 coupled to the group 104 is less than the number of local links 120 within the group, according to an embodiment. On the other hand, for each of at least some of the groups 104, the number of global links 132 coupled to the group 104 is more than the number of local links 120 within the group, according to another embodiment.

According to an embodiment, each group 104 is communicatively coupled to each other group 104 via i) direct network links 136, and ii) indirect network links 140. A direct network link 136 (sometimes referred to herein as a “direct link 136”) communicatively connects a first leaf switch 116 of a first group 104 with a second leaf switch 116 of a second group 104 directly, i.e., without any intervening leaf switches 116. For example, direct link 144 communicatively connects the leaf switch 116-11 of the group 104-1 with the leaf switch 116-x1 of the group 104-x directly, i.e., without any intervening leaf switches 116. On the other hand, an indirect network link 140 (sometimes referred to herein as an “indirect link 140”) communicatively connects a first leaf switch 116 of a first group 104 with a second leaf switch 116 of a second group 104 indirectly via one or more intervening leaf switches 116. For example, indirect link 148 communicatively connects the leaf switch 116-11 of the group 104-1 with the leaf switch 116-x1 of the group 104-x indirectly via the intervening leaf switch 116-21 of the group 104-2. The indirect link 148 includes i) a first link segment 148-1 that communicatively connects the leaf switch 116-11 of the group 104-1 with the leaf switch 116-21 of the group 104-2, and ii) a second link segment 148-2 that communicatively connects the leaf switch 116-21 of the group 104-2 with the leaf switch 116-x1 of the group 104-x. Thus, the indirect link 148 includes one hop, i.e., the leaf switch 116-21 of the group 104-2.

Paths 160 from TORs 108 of a first group 104 to TORs 108 of a second group 104 that correspond to the direct links 136 are minimal in terms of length (i.e., a number of hops between the TORs 108 of the first and second groups 104). Accordingly, the paths 160 are sometimes referred to herein as “minimal paths”. On the other hand, paths 168 from TORs 108 of a first group 104 to TORs 108 of a second group 104 that correspond to the indirect links 140 are non-minimal in terms of length (i.e., a number of hops between the TORs 108 of the first and second groups 104) because the paths 168 are longer (i.e., have more hops) than the paths 160. Accordingly, the paths 168 are sometimes referred to herein as “non-minimal paths.” Although the non-minimal paths 168 are illustrated in FIG. 1A as including paths via the group 104-2, the non-minimal paths 168 also include paths via one or more other groups 104, in some embodiments. Although the non-minimal paths 168 are illustrated in FIG. 1A as including paths with one hop, the non-minimal paths 168 also include paths with two or more hops, in some embodiments.

Although FIG. 1A illustrates direct links 136 and indirect network links 140 between the group 104-1 and the group 104-x, the global links 132 include, for each group 104, i) direct links to each other group 104, and ii) indirect links to each other group, according to some embodiments.

FIG. 1B is a simplified diagram of the communication network 100 of FIG. 1A showing minimal paths 160 from group 104-1 to group 104-x, according to an embodiment. The minimal paths 160 include: i) a subset of local links 172 within the group 104-1, ii) the direct links 136 from the group 104-1 to the group 104-x, and iii) a subset of local links 176 within the group 104-x.

FIG. 1C is a simplified diagram of the communication network 100 of FIG. 1A showing non-minimal paths 168 from group 104-1 to group 104-x, according to an embodiment. The non-minimal paths 168 include: i) the subset of local links 172 within the group 104-1, ii) the indirect links 140 from the group 104-1 to the group 104-x, and iii) the subset of local links 176 within the group 104-x. Although the non-minimal paths 168 are illustrated in FIG. 1C as including paths via the group 104-2, the non-minimal paths 168 also include paths via one or more other groups 104, in some embodiments. Although the non-minimal paths 168 are illustrated in FIG. 1C as including paths with one hop, the non-minimal paths 168 also include paths with two or more hops, in some embodiments.

Referring again to FIG. 1A, each of at least some of the TOR switches 108 includes a path selection engine 184 that is configured to select purposely, at least in some circumstances, non-minimal paths for packets destined for other groups 104 even when minimal paths are exhibiting acceptable quality levels for accepting additional flows/flowlets, according to some embodiments. In some embodiments, the path selection engines 184 are probabilistic path selection engines 184 that are configured to select, for packets destined for other groups 104, between minimal paths and non-minimal paths according to a probability distribution that favors selecting minimal paths over non-minimal paths. In some embodiments, path selection engines 184 that select, at least sometimes, nonminimal paths provide advantages over prior art load balancing techniques. For instance, always selecting minimal paths may lead to a flooding of packets to previously uncongested minimal paths, which leads to these minimal paths quickly becoming congested, whereas at least sometimes selecting nonminimal paths mitigates such flooding, at least in some embodiments.

Referring to FIGS. 1B and 1C, the TOR 108-11 includes a path selection engine 184-11 that is configured to select purposely, at least in some circumstances, non-minimal paths 168 for packets destined for the group 104-x even when minimal paths 160 are exhibiting acceptable quality levels for accepting additional flows/flowlets, according to some embodiments. In some embodiments, the path selection engines 184-11 is a probabilistic path selection engine 184-11 that is configured to select, for packets destined for the group 104-x, between the minimal paths 160 and the non-minimal paths 168 according to a probability distribution that favors selecting the minimal paths 160 over the non-minimal paths 168.

In some embodiments, the path selection engines 184 are omitted and path selections are made by the leaf switches 116.

Referring again to FIG. 1A, each of at least some of the leaf switches 116 includes a path selection engine 188 that is configured to select purposely, at least in some circumstances, non-minimal paths for packets destined for other groups 104 even when minimal paths are exhibiting acceptable quality levels for accepting additional flows/flowlets, according to some embodiments. In some embodiments, the path selection engines 184 determine, for at least some packets, whether the packets are to be transmitted via minimal paths or non-minimal paths, and informs the path selection engines 188 of the determinations; the path selection engines 188 then select between minimal paths and non-minimal paths based on the determinations made by the path selection engines 184. In other embodiments, the path selection engines 188 select between minimal paths and non-minimal paths, and the path selection engines 184 are omitted. In other embodiments, the path selection engines 188 select between minimal paths and non-minimal paths independently of path determinations, if any, made by the path selection engines 184. In some embodiments, the path selection engines 188 are probabilistic path selection engines 188 that are configured to select, for packets destined for other groups 104, between minimal paths and non-minimal paths according to a probability distribution that favors selecting minimal paths over non-minimal paths.

In some embodiments, path selection engines 188 that select, at least sometimes, nonminimal paths provide advantages over prior art load balancing techniques. For instance, always selecting minimal paths may lead to a flooding of packets to previously uncongested minimal paths, which leads to these minimal paths quickly becoming congested, whereas at least sometimes selecting nonminimal paths mitigates such flooding, at least in some embodiments.

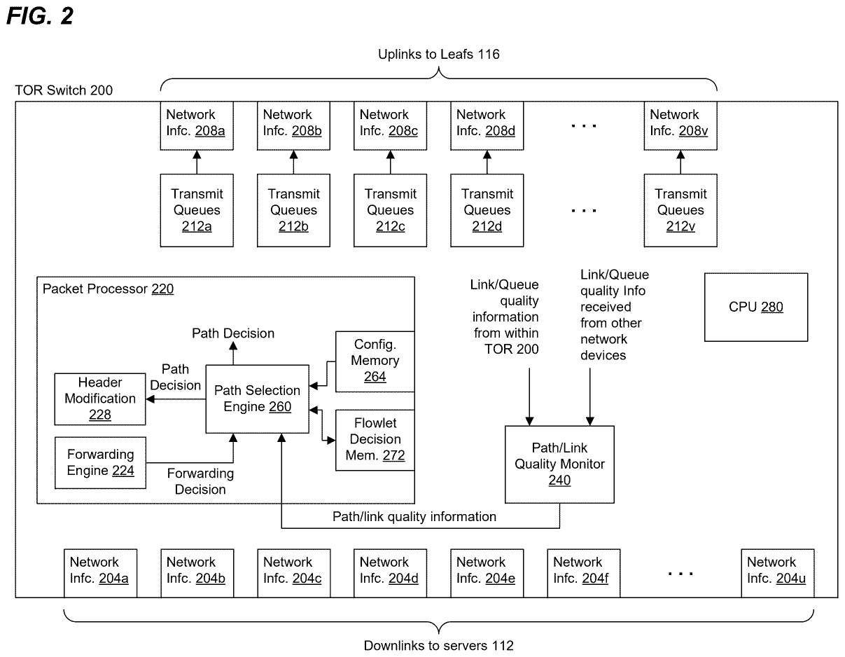

FIG. 2 is a simplified block diagram of an example TOR switch 200, according to an embodiment. In some embodiments, the TOR switch 200 is used in the communication network 100 of FIGS. 1A-C, and FIG. 2 is described with reference to FIGS. 1A-C for explanatory purposes. For example, at least some of the TOR switches 108 have a structure that same as or similar to the TOR switch 200, in some embodiments. In other embodiments, each of at least some of the TOR switches 108 have another suitable structure different than the TOR switch 200. Additionally, the TOR switch 200 is used in another suitable communication network different than the communication network 100 of FIGS. 1A-C, in some embodiments.

The TOR switch 200 includes a plurality of network interfaces 204 that are configured to communicatively couple to i) a plurality of network links to servers 112 (and/or other suitable network devices such as storage devices, etc.) and/or ii) one or more backbone network links. Each network interface 204 is configured to communicatively couple to one or more ports such as ports configured to connect with wired communication media, optical ports, etc., in some embodiments. For example, each network interface 204 is configured to communicatively couple to one or more ports via one or more of: i) one or more serializer/deserializer (SERDES) devices, ii) one or more media independent interfaces (MIIs), iii) another suitable communication link, etc., according to various embodiments.

The TOR switch 200 also includes a plurality of network interfaces 208 that are configured to communicatively couple to a plurality of network links to other network switches such as leaf switches 116. Each network interface 208 is configured to communicatively couple to one or more ports such as ports configured to connect with wired communication media, optical ports, etc., in some embodiments. For example, each network interface 208 is configured to communicatively couple to one or more ports via one or more of: i) one or more SERDES devices, ii) one or more MIIs, iii) another suitable communication link, etc., according to various embodiments.

Each network interface 208 is associated with one or more respective transmit queues 212. In some embodiments, multiple queues 212 are associated with each of at least some of the network interfaces 208. For example, the multiple queues 212 correspond with one or more of i) respective transmit priorities, ii) respective traffic classes, etc., in various embodiments.

Each queue 212 stores packets, or indications of packets, that are to be transmitted via the corresponding network interface 208.

Similarly, in some embodiments, each network interface 204 is associated with one or more respective transmit queues (not shown) that store packets, or indications of packets, that are to be transmitted via the corresponding network interfaces 204.

The TOR switch 200 also includes a packet processor 220 that processes packets received via the network interfaces 204, 208. For example, the packet processor 200 includes a forwarding engine 224 that is configured to analyze header information in packets received by the TOR switch 200 (and optionally other information not in headers of the packets) to determined network interfaces 204, 208 via which the packets are to be forwarded. In some embodiments, the forwarding engine 224 includes, or is coupled to, a forwarding database (not shown) that stores associations between header information (and optionally other information) and network interfaces 204, 208, and the forwarding engine 224 performs lookups in the forwarding database (e.g., using the header information and optionally other information) to determined network interfaces 204, 208 via which the packets are to be forwarded.

The packet processor 200 includes a header modification engine 228 that is configured to modify headers of at least some packets processed by the packet processor 220. For example, the header modification engine 228 is configured to modify fields of headers (e.g., address fields), add headers (e.g., tunnel headers) to packets, remove headers (e.g., tunnel headers) from packets, add tags to packets, etc., according to various embodiments.

The TOR switch 200 includes a quality monitor 240 that is configured to generate path/link quality information regarding paths through the communication system 100, and to provide at least some of the quality information to the packet processor 220. The quality information includes, for each of multiple paths (or multiple groups of paths) through the communication system 100 and/or for each of multiple links (or multiple groups of links) within the communication system 100, a quality metric that is indicative of a level of latency corresponding to the path/link (or group of paths/links). For ease of explanation, the quality metric is sometimes described herein as corresponding to a path and/or link, but the quality metric may also correspond to a group of paths and/or a group of links. Generally, a path through the communication system 100 may comprise one or more links.

In various embodiments, the quality information for a path/link is determined based on, or comprises, one or more measurements, metrics, etc., that are indicative of quality of the path/link with regard to one or more of congestion, latency, etc. For example, a path that is congested and/or has relatively high latency will generally have a lower quality as compared to a path with relatively lower congestion and/or relatively lower latency, in some embodiments. In some embodiments, the quality information for a path/link is determined additionally or alternatively based on, or comprises, flow control information. For example, a link that is paused (or a path including a link that is paused) as part of a flow control mechanism generally will have a lower quality as compared to a link that is not paused (or a path having no links that are paused), at least with other characteristics being equal, in an embodiment.

In some embodiments, the quality monitor 240 is configured to generate a quality metric regarding a path, group of paths, a link, or a group of links using quality information. In some embodiments, the quality monitor 240 is configured to generate a quality metric additionally or alternatively based on one or more other quality metrics regarding the path, group of paths, the link, or the group of links. In some embodiments in which a quality metric is generated using multiple pieces of quality information, the quality metric is generated using a mathematical combination of the multiple pieces of quality information.

Quality metrics regarding paths or groups of paths are sometimes referred to herein as path quality metrics (PQMs), and quality metrics regarding links or groups of links are sometimes referred to herein as link quality metrics (LQMs). Example PQMs and LQMs are described below. In other embodiments, other suitable PQMs and/or LQMs are utilized.

In an embodiment, the quality monitor 240 receives port utilization information from at least some of the network interfaces 208, where the port utilization information from each of the at least some network interfaces 208 corresponds to one or more local links 120 communicatively coupled to the network interface 208. Port utilization information provides a measure of a quantity of information (e.g., a number of bits, a number of bytes, etc.) that has been transmitted using a link coupled to the port over a unit of time. In some embodiments, port utilization information represents a quantity of data already on the link or path. Examples of port loading information include i) a number of bytes transmitted during a unit of time, ii) an average number of bytes transmitted per unit of time as measured over multiple units of time, iii) a mean number of bytes transmitted per unit of time as measured over multiple units of time, iv) an average (or mean) percentage of link capacity being used per unit of time, v) an average (or mean) data throughput of the link per unit of time, etc.

In some embodiments, the quality monitor 240 additionally or alternatively receives queue utilization information from at least some of the transmit queues 212. Queue utilization information provides a measure of a quantity of information (e.g., a number of bits, a number of bytes, etc.) that has been stored in a queue. In some embodiments, queue utilization information represents a quantity of data already stored in the queue. Examples of queue utilization information include i) a number of bytes stored to a queue during a unit of time, ii) an average number of bytes stored to the queue per unit of time as measured over multiple units of time, iii) a mean number of bytes stored to the queue per unit of time as measured over multiple units of time, iv) an amount of data stored in the queue (sometimes referred to as a “queue size”), v) an average (or mean) length of the queue during a time period (sometimes referred to as “queue depth”), vi) an average (or mean) percentage of the queue that is utilized during the time period (sometimes referred to as “queue loading”), vii) an average delay between when a packet (or indicator of the packet) is added to the queue and when the packet (or the indicator) is removed from the queue, etc.

In some embodiments, at least some queue utilization information provides a measure of a quantity of information (e.g., a number of bits, a number of bytes, etc.) that has been stored in a group of queues corresponding to a port. Examples of queue utilization information regarding a group of queues include i) a number of bytes stored to the group of queues during a unit of time, ii) an average number of bytes stored to the group of queues per unit of time as measured over multiple units of time, iii) a mean number of bytes stored to the group of queues per unit of time as measured over multiple units of time, iv) an amount of data stored in the group of queues (sometimes referred to as a “port enqueued bytes”), etc.

The latency monitor 240 is also configured to receive quality information from at least some of the leaf switches 116 to which the TOR switch 200 is connected via local links 120 (i.e., leaf switches 116 within the same group 104 as the TOR switch 200), in an embodiment, where the link quality information from each of the at least some leaf switches 116 corresponds to one or more global links 132 communicatively coupled to the leaf switch 116.

As an illustrative example, the leaf switch 116-11 in the group 104-1 provides port utilization information and/or queue utilization information for global links 132 that communicatively connect the leaf switch 116-11 to leaf switches 116 in other groups 104.

The quality information from the leaf switches 116 is the same as or similar to the quality information described above. As will be described further below, a leaf switch 116 provides to the TOR 200 quality information that is an average (or a mean) of respective quality information corresponding to multiple global links of the leaf switch 116, in an embodiment. In another embodiment, the leaf switch 116 selects one global link (e.g., a global link with a lowest utilization) of the leaf switch 116 and provides to the TOR 200 quality information for the selected global link rather than quality information corresponding to multiple global links.

In some embodiments, the quality monitor 240 additionally or alternatively receives quality information from at least some of the leaf switches 116 to which the TOR switch 200 is connected via local links 120 (i.e., leaf switches 116 within the same group 104 as the TOR switch 200), in an embodiment, where the quality information from each of the at least some leaf switches 116 corresponds to one or more global links 132 communicatively coupled to the leaf switch 116. As an illustrative example, the leaf switch 116-11 in the group 104-1 provides quality information for global links 132 that communicatively connect the leaf switch 116-11 to leaf switches 116 in other groups 104.

The quality information from the leaf switches 116 is the same as or similar to the quality information described above. As will be described further below, a leaf switch 116 provides to the TOR 200 quality information that is an average (or a mean) of respective quality information corresponding to multiple global links of the leaf switch 116, in an embodiment. In another embodiment, the leaf switch 116 selects one global link (e.g., a global link with a lowest utilization) of the leaf switch 116 and provides to the TOR 200 quality information for the selected global link rather than quality information corresponding to multiple global links.

The quality monitor 240 is configured to generate quality information for paths through the network switching system 100 using i) quality regarding local links 120 and ii) quality received from at least some of the leaf switches 116, in an embodiment. For instance, in an embodiment, the quality monitor 240 is configured to generate quality information for paths through the network switching system 100 using i) quality information regarding local links 120, and ii) quality information received from at least some of the leaf switches 116, in an embodiment. In an embodiment, the quality monitor 240 generates quality information for i) minimal paths such as described above, and ii) non-minimal paths such as described above. In an embodiment, the quality monitor 240 generates the quality information as a metric (e.g., a PQM), which is generated as a suitable function of i) quality information regarding local links 120, and ii) quality information received from at least some of the leaf switches 116. In an illustrative embodiment, the quality monitor 240 generates a PQM for each of multiple minimal paths and each of multiple non-minimal paths as a suitable function of i) port utilization information regarding one or more local links 120 corresponding to the path, ii) queue utilization information regarding one or more local links 120 corresponding to the path, iii) port utilization information regarding the path received from a corresponding leaf switch 116, and iv) queue utilization information received from the leaf switch 116 corresponding to the path. In other embodiments, the quality monitor 240 generates a PQM for each of multiple minimal paths and each of multiple non-minimal paths additionally or alternatively using other suitable quality information and/or flow control state information.

In some embodiments, quality information such as described above is quantized. In some embodiments, quality information such as described above is linearly quantized. As an illustrative example, a port loading metric is linearly quantized to four levels: 0-25% capacity, 25-50% capacity, 50-75% capacity, and 75-100% v. In some embodiments, quality information such as described above is nonlinearly quantized. As an illustrative example, a port loading metric is nonlinearly quantized to four levels: 0-5% capacity, 5 -15% capacity, 15-35% capacity, and 35-100% capacity. In other embodiments, quality information such as described above is linearly, nonlinearly, or otherwise quantized to a suitable number of possible values other than four.

In an example, the packet processor 220 includes a path selection engine 260 that is configured to select, for each of at least some packets (or each of at least some packet flows, flowlets, etc.) received by the TOR switch 200, a set of one or more paths through the network switching system 100. The path selection engine 260 uses a forwarding decision from the forwarding engine 224 to select the set of one or more paths, in some embodiments. The path selection engine 260 also selects the set of one or more paths based on quality information received from the quality monitor 240.

The path selection engine 260 is coupled to a configuration memory that stores configuration information for the path selection engine 260, in an embodiment. The configuration information configures how the path selection engine 260 selects paths through the network switching system 100, in an embodiment. For example, the configuration information configures how often the path selection engine 260 selects non-minimal paths rather minimal paths, in an embodiment. The configuration information configures the path selection engine 260 so that the path selection engine 260 sometimes selects non-minimal paths but more often selects minimal paths, at least in some situations. More generally, the configuration information defines a policy for selecting minimal versus non-minimal paths based on states of the paths and the performance goals for network applications, in some embodiments. In some embodiments, the configuration information is set by, and/or can be changed by, a user.

In an embodiment, the path selection engine 260 is, or includes, a probabilistic path selection engine 260 that makes path selection decisions according to one or more probabilities stored in the configuration memory 264. The one or more probabilities favor minimal paths over non-minimal paths so that the path selection engine 260 sometimes selects non-minimal paths but more often selects minimal paths, at least in some situations.

The probabilistic path selection engine 260 is configured to pseudorandomly select paths based on the one or more probabilities stored in the configuration memory 264, according to an embodiment. As an illustrative example, the probabilistic path selection engine 260 pseudorandomly select paths based on a probability that results in the probabilistic path selection engine 260 mostly selecting minimal paths but sometimes selecting non-minimal paths. In another embodiment, the probabilistic path selection engine 260 is replaced with a deterministic path selection engine that is configured to select paths according to path selection configuration information stored in the configuration memory 264, where the path selection configuration information determines how often the deterministic path selection engine selects minimal paths versus non-minimal paths. As an illustrative example, the deterministic path selection engine selects paths (e.g., in a round robin manner, according to a deterministic pattern, etc.) such that the deterministic path selection engine mostly selects minimal paths but sometimes selects non-minimal paths according to the path selection configuration information.

The path selection engine 260 is configured to make a path selection decision for a packet in a packet flow, and then use the same decision for at least some subsequent packets in the packet flow, according to some embodiments. A packet flow is a group of packets that have a same set of one or more packet header field values and/or other characteristics. As an illustrative example, a packet flow is a group of packets having i) a same source Internet protocol (IP) address, ii) a same destination IP address, and iii) a same IP protocol field value, in an embodiment. As another illustrative example, a packet flow is a group of packets having i) a same source IP address, ii) a same destination IP address, iii) a same source transmission control protocol (TCP)/user datagram protocol (UDP) port, iv) a same destination TCP/UDP port, and v) a same IP protocol field value, iv) in an embodiment. In other embodiments, a packet flow is defined to have a same set of one or more header field values and/or other characteristics in addition to, or instead of, the header field values discussed above.

In some embodiments, the path selection engine 260 is configured to make a path selection decision for a packet in a flowlet, and then use the same decision for at least some subsequent packets in the flowlet, according to some embodiments. A flowlet is a portion of a packet flow in time. For example, a packet flow often includes multiple bursts of packets, where adjacent bursts are spaced apart in time. Such bursts may be considered flowlets, in an embodiment. For example, when gaps between packets in a flow are sufficiently low (e.g., below a threshold), the packets are considered to be part of a same flowlet; on the other hand, when a gap between two packets is sufficiently large (e.g., above the threshold), the subsequent packet is eligible to be assigned to a new flowlet, in an embodiment. In some embodiments, the threshold is configurable, such as configurable per port, per queue, per flow, per packet type, etc. In some such embodiments, the threshold can be set to a sufficiently low level such that every packet is considered to be eligible to be assigned to a new flowlet, and the threshold can be set to a sufficiently high level such that packets in a flow are never considered to be eligible to be assigned to a new flowlet.

In other embodiments, a packet flow is divided into flowlets at fixed time intervals.

In other embodiments, a packet flow is divided into flowlets according to other suitable techniques.

In some embodiments in which the path selection engine 260 is configured to make a path selection decision for a packet in a packet flow or flowlet, and then use the same decision for at least some subsequent packets in the packet flow or flowlet, the packet processor 220 also includes a memory 272 to store decisions made by the path selection engine 260 for packet flows/flowlets. When a subsequent packet in a packet flow/flowlet is received, the path selection engine 260 is configured to lookup the path decision previously made for the packet flow/flowlet to which the packet belongs. In an embodiment, each of at least some path decision entries in the memory 272 is associated with a respective timeout parameter that indicates a time period since the path decision entry was last accessed in connection with forwarding a packet in the corresponding flow/flowlet. In another embodiment, each of at least some path decision entries in the memory 272 is associated with a respective timeout parameter that indicates a time period since the path decision entry was created, and the TOR switch 200 performs an aging process to remove from the memory 272 path decision entries for which the time period exceeds a threshold.

The path selection engine 260 is configured to select purposely, at least in some circumstances, non-minimal paths for packets destined for other groups 104 even when minimal paths are exhibiting acceptable quality levels for accepting additional flows/flowlets, according to some embodiments. In some embodiments, the path selection engine 260 is, or includes, a probabilistic path selection engine that is configured to select, for packets destined for other groups 104, between minimal paths and non-minimal paths according to a probability that favors selecting minimal paths over non-minimal paths. In some embodiments, the path selection engine 260 selecting, at least sometimes, nonminimal paths provide advantages over prior art load balancing techniques. For instance, always selecting minimal paths may lead to a flooding of packets to previously uncongested minimal paths, which leads to these minimal paths quickly becoming congested, whereas at least sometimes selecting non-minimal paths mitigates such flooding, at least in some embodiments.

The TOR switch 200 also includes a processor 280 (sometimes referred to as the “central processing unit 280” or the “CPU 280”) that executes machine readable instructions stored in a memory (not shown) coupled to the CPU 280. In an embodiment, the CPU 280 is configured to write configuration information in the configuration memory 264. In an embodiment, the CPU 280 is configured to perform an aging function regarding entries in the flowlet decision memory 272.

In another embodiment, the CPU 280 does not execute the aging function. For instance, the path selection engine 260 is configured to perform an aging process in connection with accessing a path decision entries in the memory 272, in an embodiment. For example, when accessing a path decision entries in the memory 272, the path selection engine 260 examines a timeout parameter to determine whether the path decision entry in the memory 272 should be updated, according to an embodiment. In response to determining that the path decision entry should be updated, the path selection engine 260 makes a new path decision (e.g., using techniques such as described herein or another suitable technique) and updates, in the memory 272, the indication of the path decision associated with the flow/flowlet to reflect the new path decision, according to an embodiment. In response to determining that the path decision entry should not be updated from the memory 272, the path selection engine 260 uses the path decision indicated by the path decision entry in the memory 272, according to an embodiment.

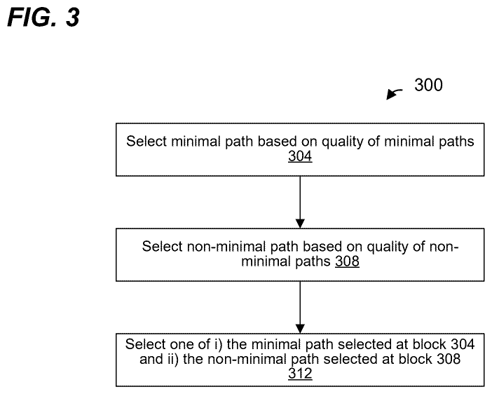

FIG. 3 is a flow diagram of an example method 300 for selecting a path through a network switching system for transmitting a packet, according to an embodiment. The method 300 is performed by a network device such as the TOR switch 108 and/or the TOR switch 200, and the method 300 is described with reference to FIGS. 1A-C and 2 for explanatory purposes. In other embodiments, the method 300 is performed by another suitable network device. In some embodiments, the TOR switch 108 and/or the TOR switch 200 perform another suitable method for selecting a path through a network switching system different than the method 300.

At block 304, a network device selects (e.g., the TOR switch 108 selects, the TOR switch 200 selects, the packet processor 200 selects, the path selection engine 260 selects, etc.) a minimal path, from amongst multiple minimal paths through the network switching system, for the packet based on quality information (e.g., PQMs) for the multiple minimal paths. Examples techniques for selecting the minimal path at block 304 are described below. In an embodiment, selecting the minimal path at block 304 comprises selecting a local link 120 to a particular leaf switch 116, where the leaf switch 116 is permitted to select a global link for the packet from amongst multiple global links to the destination group 104. In some such embodiments, block 304 comprises the network device selecting a set of multiple minimal paths that each comprise the selected local link.

At block 308, the network device selects (e.g., the TOR switch 108 selects, the TOR switch 200 selects, the packet processor 200 selects, the path selection engine 260 selects, etc.) a non-minimal path, from amongst multiple non-minimal paths through the network switching system, for the packet based on quality information (e.g., PQMs) for the multiple non-minimal paths. Examples techniques for selecting the non-minimal path at block 308 are described below. In an embodiment, selecting the non-minimal path at block 308 comprises selecting a local link 120 to a particular leaf switch 116, where the leaf switch 116 is permitted to select a global link for the packet from amongst multiple global links to the destination group 104. In some such embodiments, block 308 comprises the network device selecting a set of multiple non-minimal paths that each comprise the selected local link.

At block 312, the network device selects (e.g., the TOR switch 108 selects, the TOR switch 200 selects, the packet processor 200 selects, the path selection engine 260 selects, etc.) for the packet one of i) the minimal path (or the set of multiple minimal paths) selected at block 304 and ii) the non-minimal path (or the set of multiple non-minimal paths) selected at block 308. Examples techniques for performing the selection at block 312 are described below. Performing the selection at block 312 sometimes results in the non-minimal path (or the set of multiple non-minimal paths) being selected for the packet even when minimal path (or set of multiple minimal paths) selected at block 304 are exhibiting acceptable quality levels for accepting additional flows/flowlets, in some embodiments. In an embodiment, performing the selection at block 312 comprises probabilistically selecting for the packet the one of i) the minimal path (or the set of multiple minimal paths) and ii) the non-minimal path (or the set of one or more non-minimal paths) according to a probability function that favors selecting the minimal path (or the set of multiple minimal paths).

The network device forwards (e.g., the TOR switch 108 forwards, the TOR switch 200 forwards, the packet processor 200 forwards, etc.) the packet via a link (e.g., a local link 120) to another network device (e.g., a leaf switch 116), where the link corresponds to the one of i) the minimal path (or the set of multiple minimal paths) and ii) the non-minimal path (or the set of one or more non-minimal paths) selected at block 312.

In some embodiments, after the selection is performed at block 312, the network device adds (e.g., the TOR switch 108 adds, the TOR switch 200 adds, the packet processor 200 adds, the header modification engine 228 adds, etc.) a tag to the packet to indicate the selection. In some embodiments in which the leaf switch 116 is permitted to select from amongst multiple global links, the tag indicates whether the leaf switch is to select from amongst direct links or amongst indirect links. In some embodiments in which the network device selects the entire path, the tag indicates the particular link via which the leaf switch is to forward the packet.

In another embodiment, the network device selection between minimal paths and non-minimal paths is performed at block 312 prior to performing block 304 or block 308. Then, in response to selecting minimal paths, the network device performs the selection at block 304. Additionally, in response to selecting non-minimal paths, the network device performs the selection at block 308.

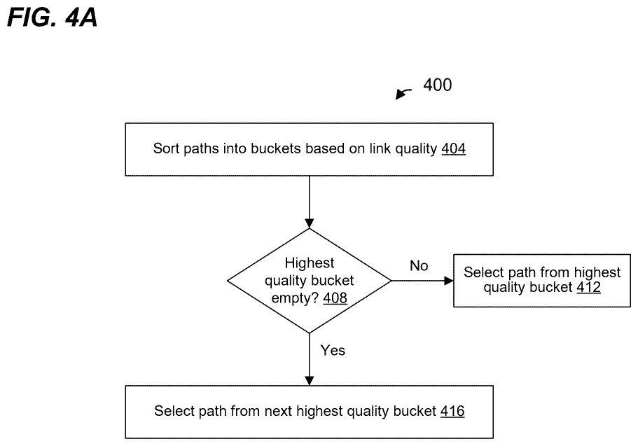

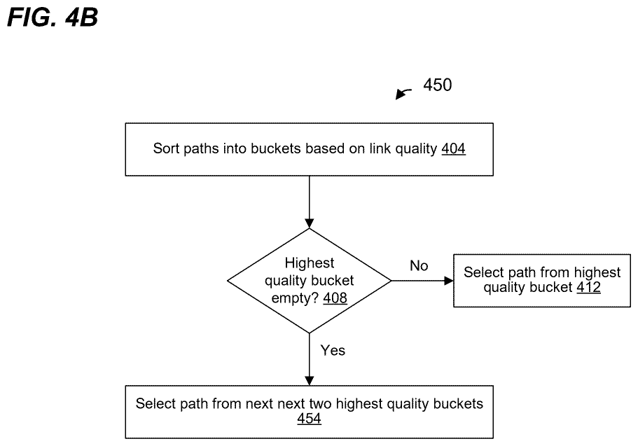

FIG. 4A is a flow diagram of an example method 400 for selecting a path through a network switching system for transmitting a packet, according to an embodiment. The method 400 is performed by a network device such as the TOR switch 108 and/or the TOR switch 200, and the method 400 is described with reference to FIGS. 1A-C, and 2 for explanatory purposes. In other embodiments, the method 400 is performed by another suitable network device. In some embodiments, the TOR switch 108 and/or the TOR switch 200 perform another suitable method for selecting a path through a network switching system different than the method 400.

The method 400 is an example method for selecting a minimal path at block 304 of FIG. 3, according to an embodiment, and the method 400 is described with reference to FIG. 3 for explanatory purposes. Additionally or alternatively, the method 400 is an example method for selecting a non-minimal path at block 308 of FIG. 3, according to another embodiment. In other embodiments, the method 400 is performed in connection with another suitable method other than the method 300. In some embodiments, the method 300 involves another suitable method for selecting paths different than the method 400.

At block 404, the network device sorts (e.g., the TOR switch 108 sorts, the TOR switch 200 sorts, the packet processor 200 sorts, the path selection engine 260 sorts, etc.) into a plurality of buckets path indicators for respective paths from a set of paths (e.g., a set of minimal paths, a set of non-minimal paths, etc.) based on quality information (e.g., PQMs) for the paths. Respective buckets correspond to respective levels of quality. In an embodiment, block 404 comprises the network device sorting (e.g., the TOR switch 108 sorting, the TOR switch 200 sorting, the packet processor 200 sorting, the path selection engine 260 sorting, etc.) into a plurality of buckets path indicators for respective paths from a set of paths (e.g., a set of minimal paths, a set of subminimal paths, etc.) based on quality information (e.g., PQMs) for the paths. Respective buckets correspond to respective levels of quality. In an illustrative embodiment that includes four buckets, the buckets correspond to the following levels of quality: i) a very high, ii) high, iii) moderate, and iv) low. In other embodiments with four buckets, the buckets correspond to other suitable levels of quality. In other embodiments, suitable numbers of buckets other than four are utilized. In some embodiments in which the quality information comprises PQMs, respective buckets correspond to respective ranges of PQM values. In various embodiments, the ranges have a same width or two or more different widths.

At block 408, the network device determines (e.g., the TOR switch 108 determines, the TOR switch 200 determines, the packet processor 200 determines, the path selection engine 260 determines, etc.) whether a highest quality bucket is empty. If the network device determines (e.g., the TOR switch 108 determines, the TOR switch 200 determines, the packet processor 200 determines, the path selection engine 260 determines, etc.) that the highest quality bucket is not empty, the flow proceeds to block 412. At block 412, the network device selects (e.g., the TOR switch 108 selects, the TOR switch 200 selects, the packet processor 200 selects, the path selection engine 260 selects, etc.) a path that corresponds to quality information sorted into the highest quality bucket. If the highest quality bucket includes more than one path, selecting the path at block 412 comprises selecting the path randomly (e.g., pseudorandomly), according to an embodiment. In other embodiments, the path is selected at block 412 using another suitable technique when the highest quality bucket includes more than one path.

In an embodiment, selecting the path at block 412 comprises selecting a local link 120 to a particular leaf switch 116, where the leaf switch 116 is permitted to select a global link for the packet from amongst multiple global links to the destination group 104. In some such embodiments, block 412 comprises the network device selecting a set of multiple paths that each comprise the selected local link.

On the other hand, if the network device determines (e.g., the TOR switch 108 determines, the TOR switch 200 determines, the packet processor 200 determines, the path selection engine 260 determines, etc.) at block 408 that the highest quality bucket is empty, the flow proceeds to block 416. At block 416, the network device selects (e.g., the TOR switch 108 selects, the TOR switch 200 selects, the packet processor 200 selects, the path selection engine 260 selects, etc.) a path sorted into a bucket that corresponds to a next highest quality as compared to the highest quality bucket. If the next highest quality bucket includes more than one path, selecting the path at block 416 comprises selecting the path randomly (e.g., pseudorandomly), according to an embodiment. In other embodiments, the path is selected at block 416 using another suitable technique when the next highest quality bucket includes more than one path.

In an embodiment, selecting the path at block 416 comprises selecting a local link 120 to a particular leaf switch 116, where the leaf switch 116 is permitted to select a global link for the packet from amongst multiple global links to the destination group 104. In some such embodiments, block 416 comprises the network device selecting a set of multiple paths that each comprise the selected local link.

FIG. 4B is a flow diagram of another example method 450 for selecting a path through a network switching system for transmitting a packet, according to another embodiment. The method 450 is performed by a network device such as the TOR switch 108 and/or the TOR switch 200, and the method 450 is described with reference to FIGS. 1A-C, and 2 for explanatory purposes. In other embodiments, the method 450 is performed by another suitable network device. In some embodiments, the TOR switch 108 and/or the TOR switch 200 perform another suitable method for selecting a path through a network switching system different than the method 450.

The method 450 is another example method for selecting an minimal path at block 304 of FIG. 3, according to an embodiment, and the method 450 is described with reference to FIG. 3 for explanatory purposes. Additionally or alternatively, method 450 is another example method for selecting a non-minimal path at block 308 of FIG. 3, according to another embodiment. In other embodiments, the method 450 is performed in connection with another suitable method other than the method 300. In some embodiments, the method 300 involves another suitable method for selecting paths different than the method 450.

The method 450 is similar to the method 400 of FIG. 4A, and like-numbered elements are not discussed again in detail for brevity.

If the network device determines (e.g., the TOR switch 108 determines, the TOR switch 200 determines, the packet processor 200 determines, the path selection engine 260 determines, etc.) at block 408 that the highest quality bucket is empty, the flow proceeds to block 454. At block 454, the network device selects (e.g., the TOR switch 108 selects, the TOR switch 200 selects, the packet processor 200 selects, the path selection engine 260 selects, etc.) a path from a set of paths sorted into two buckets that corresponds to two next highest qualities as compared to the highest quality bucket, i.e., a second highest quality bucket and a third highest quality bucket.

If the second and third highest quality buckets include more than one path, selecting the path at block 454 comprises selecting the path randomly (e.g., pseudorandomly), according to an embodiment. In another embodiment, selecting the path at block 454 comprises probabilistically selecting the path from the second highest quality bucket with a probability X, and selecting the path from the third highest quality bucket with a probability X-1, according to another embodiment. In an embodiment, X is chosen to favor selection from the second highest quality bucket, at least in some situations. In other embodiments, X is chosen in another suitable manner.

Selecting the path in the manner of block 454 results in the path sometimes being selected from the third highest quality bucket rather than the second highest quality bucket, which provides advantages such as described above. Paths in the third highest quality bucket may be considered suboptimal with respect to the second highest quality bucket because paths in the third highest quality bucket are exhibiting lower quality as compared to paths in the second highest quality bucket.

In other embodiments, the path is selected at block 454 using another suitable technique when the second and third highest quality buckets include more than one path.

In an embodiment, selecting the path at block 454 comprises selecting a local link 120 to a particular leaf switch 116, where the leaf switch 116 is permitted to select a global link for the packet from amongst multiple global links to the destination group 104. In some such embodiments, block 454 comprises the network device selecting a set of multiple paths that each comprise the selected local link.

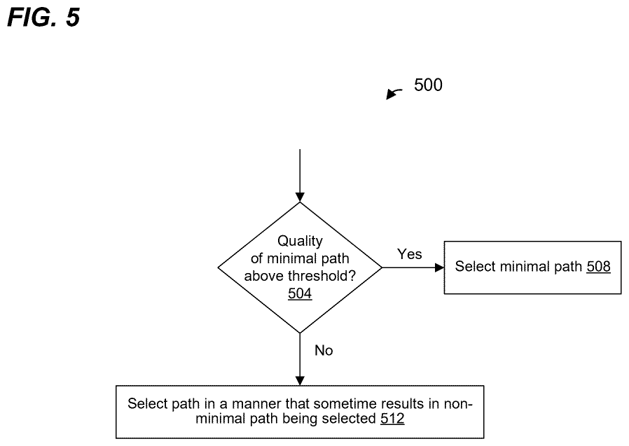

FIG. 5 is a flow diagram of an example method 500 for selecting a path through a network switching system for transmitting a packet, according to an embodiment. The method 500 is performed by a network device such as the TOR switch 108 and/or the TOR switch 200, and the method 500 is described with reference to FIGS. 1A-C, and 2 for explanatory purposes. In other embodiments, the method 500 is performed by another suitable network device. In some embodiments, the TOR switch 108 and/or the TOR switch 200 perform another suitable method for selecting a path through a network switching system different than the method 500.

The method 500 is an example method for selecting a path at block 312 of FIG. 3, according to an embodiment, and the method 500 is described with reference to FIG. 3 for explanatory purposes. In some embodiments, the method 300 involves another suitable method for selecting paths different than the method 500.

At block 504, the network device determines (e.g., the TOR switch 108 determines, the TOR switch 200 determines, the packet processor 200 determines, the path selection engine 260 determines, etc.) whether a quality level of a chosen minimal path (e.g., chosen at block 304) is above a threshold. Determining whether the quality level is above the threshold comprises determining whether a PQM for the minimal path is above the threshold, in an embodiment. Determining whether the quality level is above the threshold comprises determining both i) that a port utilization level is below a first threshold, and ii) that a queue utilization level is below a second threshold, in another embodiment.

If the network device determines (e.g., the TOR switch 108 determines, the TOR switch 200 determines, the packet processor 200 determines, the path selection engine 260 determines, etc.) that the quality level is above the threshold, the flow proceeds to block 508. At block 508, the network device selects (e.g., the TOR switch 108 selects, the TOR switch 200 selects, the packet processor 200 selects, the path selection engine 260 selects, etc.) the minimal path.

On the other hand, if the network device determines (e.g., the TOR switch 108 determines, the TOR switch 200 determines, the packet processor 200 determines, the path selection engine 260 determines, etc.) that the quality level is below the threshold, the flow proceeds to block 512. At block 512, the network device selects (e.g., the TOR switch 108 selects, the TOR switch 200 selects, the packet processor 200 selects, the path selection engine 260 selects, etc.) one of i) the minimal path and ii) the non-minimal path in a manner such that the network device sometimes selects the non-minimal path even when the minimal path is exhibiting acceptable quality levels for accepting additional flows/flowlets. In an embodiment, selecting the path at block 512 comprises probabilistically selecting one of i) the minimal path and ii) the non-minimal path according to a probability function that favors selecting the minimal path. In an embodiment, the probability function varies depending on a quality level of the minimal path. In an embodiment, the probability function varies depending on a quality level of the non-minimal path. In an embodiment, the probability function varies depending on the quality level of the minimal path and the quality level of the non-minimal path. In an embodiment, the probability function varies over time.

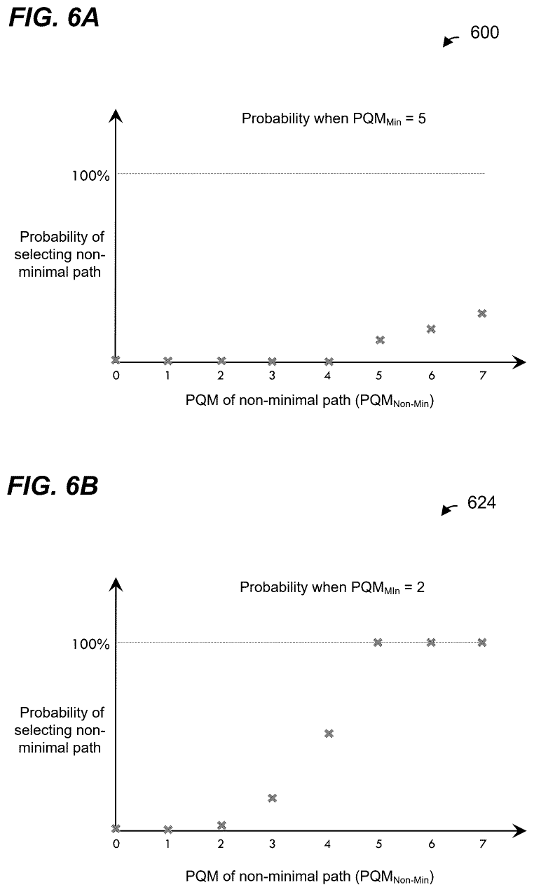

FIG. 6A is a plot of an example probability function 600 used by a network device (e.g., the TOR switch 108, the TOR switch 200, the packet processor 200, the path selection engine 260, etc.) to probabilistically select one of i) the minimal path and ii) the non-minimal path, according to an embodiment. The probability function 600 corresponds to PQMs that have eight levels, where increasing values of the PQM correspond to increasing levels of quality. For example, a PQM of zero indicates very low quality, whereas a PQM of seven indicates very high quality.

The probability distribution function 600 corresponds to a PQM of the minimal path (PQM_{Min}) of five. As can be seen in FIG. 6A, when the PQM of the non-minimal path (PQM_{Non-Min}) is four or less, the minimal path will always be selected (i.e., the probability of selecting the minimal path is 100%). As PQM_{Non-Min} increases above four, the chance of selecting the non-minimal path increases. For instance, when PQM_{Non-Min} is five, the probability of selecting the non-minimal path is about 10%; when PQM_{Non-Min} is six, the probability of selecting the non-minimal path is about 17%; and when PQM_{Non-Min} is seven, the probability of selecting the non-minimal path is about 25%.

FIG. 6B is a plot of another example probability function 624 used by a network device (e.g., the TOR switch 108, the TOR switch 200, the packet processor 200, the path selection engine 260, etc.) to probabilistically select one of i) the minimal path and ii) the non-minimal path, according to an embodiment. As in FIG. 6A, the probability function 624 corresponds to PQMs that have eight levels, where increasing values of the PQM correspond to increasing levels of quality.

The probability function corresponds to a PQM_{Min} of two. As can be seen in FIG. 6B, when PQM_{Non-Min} is two or less, the minimal path will always be selected (i.e., the probability of selecting the minimal path is 100%). As PQM_{Non-Min} increases above two, the chance of selecting the non-minimal path increases. When PQM_{Non-Min} is five or more, the non-minimal path will always be selected (i.e., the probability of selecting the subminimal path is 100%). When PQM_{Non-Min} is two, the probability of selecting the non-minimal path is about 3%; when PQM_{Non-Min} is three, the probability of selecting the non-minimal path is about 17%; and when PQM_{Non-Min} is four, the probability of selecting the non-minimal path is about 50%.

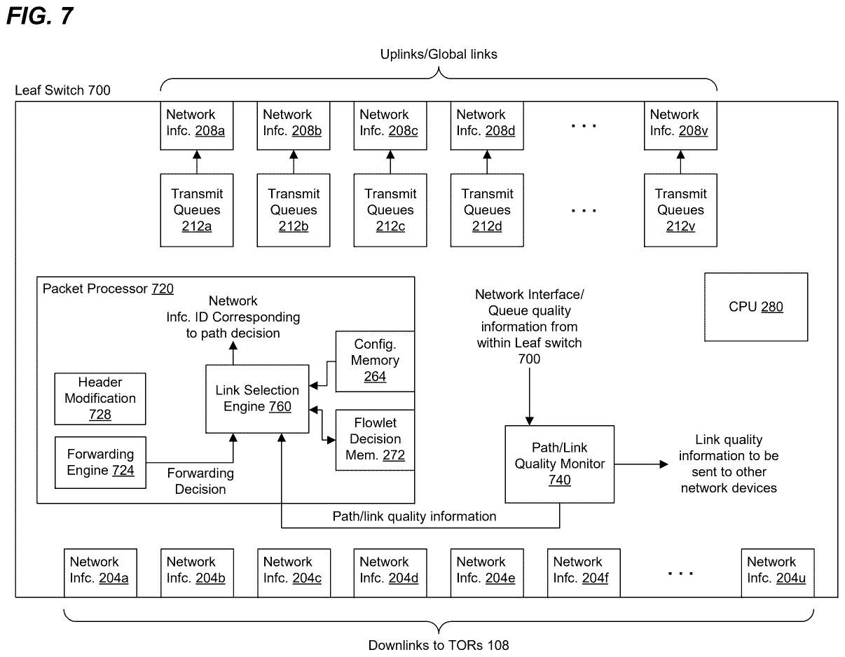

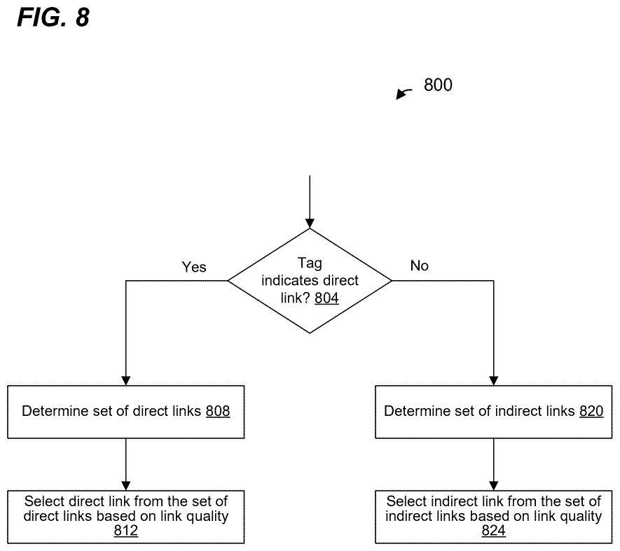

FIG. 7 is a simplified block diagram of an example leaf switch 700, according to an embodiment. In some embodiments, the leaf switch 700 is used in the communication network 100 of FIGS. 1A-C, and FIG. 7 is described with reference to FIGS. 1A-C for explanatory purposes. For example, at least some of the leaf switches 116 have a structure that same as or similar to the leaf switch 700, in some embodiments. In other embodiments, each of at least some of the leaf switches 116 have another suitable structure different than the leaf switch 700. Additionally, the leaf switch 700 is used in another suitable communication network different than the communication network 100 of FIGS. 1A-C, in some embodiments.

The leaf switch 700 includes a packet processor 720 that processes packets received via the network interfaces 204, 208. For example, the packet processor 720 includes a forwarding engine 724 that is configured to analyze header information in packets received by the leaf switch 700 (and optionally other information not in headers of the packets) to determined network interfaces 204, 208 via which the packets are to be forwarded. In some embodiments, the forwarding engine 724 includes, or is coupled to, a forwarding database (not shown) that stores associations between header information (and optionally other information) and network interfaces 204, 208, and the forwarding engine 724 performs lookups in the forwarding database (e.g., using the header information and optionally other information) to determined network interfaces 204, 208 via which the packets are to be forwarded.

In some embodiments, the forwarding engine 724 is configured to analyze tags added to packets by TOR switches 108 to determine network interfaces 204, 208 via which the packets are to be forwarded.

The packet processor 700 includes a header modification engine 728 that is configured to modify headers of at least some packets processed by the packet processor 720. For example, the header modification engine 728 is configured to modify fields of headers (e.g., address fields), add headers (e.g., tunnel headers) to packets, remove headers (e.g., tunnel headers) from packets, add tags to packets, etc., according to various embodiments. In an embodiment, the header modification engine 728 is configured to remove from packets tags that were added by the TOR switches 108.

The leaf switch 700 includes a quality monitor 740 that is configured to generate quality information regarding paths through the communication system 100, and to provide the quality information to the packet processor 720. The quality information includes, for each of multiple paths through the communication system 100, quality information such as described above.

In an embodiment, the quality monitor 740 receives port utilization information from at least some of the network interfaces 208, where the port utilization information from each of the at least some network interfaces 208 corresponds to one or more global links 132 communicatively coupled to the network interface 208. In some embodiments, the quality monitor 740 additionally or alternatively receives queue utilization information from at least some of the transmit queues 212.

The latency monitor 740 is also configured to transmit quality information to at least some of the TOR switches 108 to which the leaf switch 700 is connected via local links 120 (i.e., TOR switches 108 within the same group 104 as the leaf switch 700), in an embodiment, where the quality information corresponds to one or more global links 132 communicatively coupled to the leaf switch 116. As an illustrative example, the leaf switch 116-11 in the group 104-1 provides quality information for global links 132 that communicatively connect the leaf switch 116-11 to leaf switches 116 in other groups 104.

In some embodiments, the quality monitor 740 generates quality information that is an average (or a mean) of respective quality information corresponding to multiple global links of the leaf switch 700, in an embodiment. In another embodiment, the quality monitor 740 selects one global link (e.g., a global link with a lowest utilization) of the leaf switch 700 and provides to TOR switches 108 quality information for the selected global link rather than quality information corresponding to multiple global links.

The quality monitor 740 is configured to generate quality information for different global links 132 using one or both of a) port utilization information such as described above and b) queue utilization information such as described above, in an embodiment. In an embodiment, the quality monitor 740 generates quality information for i) direct links, and ii) indirect links, such as described above. In an embodiment, the quality monitor 740 generates the quality information as a metric (e.g., an LQM), such as described above. In an illustrative embodiment, the congestion monitor 274 generates LQMs for each multiple direct links and each of multiple indirect links as a suitable function of i) port utilization information corresponding to the link, and iv) queue utilization information corresponding to the link.

The packet processor 720 includes a link selection engine 760 that is configured to select, for each of at least some packets (or each of at least some packet flows, flowlets, etc.) received by the leaf switch 700, a global link 132. The link selection engine 760 uses path selection information in a tag of the packet, such as a tag added to the packet by a TOR switch 108, in some embodiments. In some embodiments, the link selection engine 760 additionally or alternatively uses a forwarding decision from the forwarding engine 724 to select the global link. The link selection engine 760 also selects the global link additionally or alternatively based on quality information received from the quality monitor 740.

The link selection engine 760 is coupled to the configuration memory 264 that stores configuration information for the link selection engine 760, in an embodiment. The configuration information configures how the link selection engine 760 selects global links, in an embodiment. The link selection engine 760 and the configuration information in the configuration memory 264 operate in a manner similar to the path selection engine 260 and the configuration information discussed with reference to FIG. 2.

In an embodiment, the link selection engine 760 is, or includes, a probabilistic link selection engine 760 that makes link selection decisions according to one or more probabilities stored in the configuration memory 264. The one or more probabilities favor direct links over indirect links so that the link selection engine 760 sometimes selects indirect links but more often selects direct links, at least in some situations. The probabilistic path selection engine 760 is configured to pseudorandomly select links based on the one or more probabilities stored in the configuration memory 264, according to an embodiment. As an illustrative example, the probabilistic path selection engine 760 pseudorandomly select paths based on a probability that results in the probabilistic path selection engine 760 mostly selecting direct links but sometimes indirect inks. In another embodiment, the probabilistic path selection engine 760 is replaced with a deterministic path selection engine that is configured to select links according to link selection configuration information stored in the configuration memory 264, where the link selection configuration information determines how often the deterministic link selection engine selects direct links versus indirect links. As an illustrative example, the deterministic path selection engine selects links (e.g., in a round robin manner, according to a deterministic pattern, etc.) such that the deterministic link selection engine mostly selects direct links but sometimes selects indirect links according to the link selection configuration information.

The link selection engine 760 is configured to make a link selection decision for a packet in a packet flow, and then use the same decision for at least some subsequent packets in the packet flow, according to some embodiments. In some embodiments, the link selection engine 760 is configured to make a link selection decision for a packet in a flowlet, and then use the same decision for at least some subsequent packets in the flowlet, according to some embodiments.

In some embodiments in which the link selection engine 760 is configured to make a link selection decision for a packet in a packet flow or flowlet, and then use the same decision for at least some subsequent packets in the packet flow or flowlet, the packet processor 720 also includes the memory 272 to store decisions made by the link selection engine 760 for packet flows/flowlets. When a subsequent packet in a packet flow/flowlet is received, the link selection engine 760 is configured to look up in the memory 272 the path decision previously made for the packet flow/flowlet to which the packet belongs. In an embodiment, the leaf switch 700 performs an aging process to remove from the memory 272 path decision entries using techniques such as described herein.

The link selection engine 760 is configured to select purposely, at least in some circumstances, indirect links for packets destined for other groups 104 even when direct links are exhibiting acceptable quality levels for accepting additional flows/flowlets, according to some embodiments. The link selection engine 760 is configured to select purposely, at least in some circumstances, an indirect link for a packet destined for another group 104 over a direct link that exhibits an acceptable quality levels for accepting additional flows/flowlets, according to some embodiments. In some embodiments, the link selection engine 760 is, or includes, a probabilistic link selection engine that is configured to select, for packets destined for other groups 104, between direct links and indirect links according to a probability that favors selecting direct links over indirect links, at least in some situations. In some embodiments, the link selection engine 760 selecting, at least sometimes, indirect links provide advantages over prior art load balancing techniques such as described above.

FIG. 8 is a flow diagram of an example method 800 for selecting a link in a network switching system for transmitting a packet, according to an embodiment. The method 800 is performed by a network device such as the leaf switch 116 and/or the leaf switch 700, and the method 800 is described with reference to FIGS. 1A-C and 7 for explanatory purposes. In other embodiments, the method 800 is performed by another suitable network device. In some embodiments, the leaf switch 116 and/or the leaf switch 700 perform another suitable method for selecting a link in a network switching system different than the method 800.

At block 804, a network device determines (e.g., the leaf switch 116 determines, the leaf switch 700 determines, the packet processor 720 determines, the forwarding engine 724 determines, the path selection engine 760 determines, etc.) whether a tag of a packet indicates that the packet is to be transmitted by the network device to another group 104 via a direct link. In response to determining at block 804 that the packet is to be transmitted via a direct link, the flow proceeds to block 808.

At block 808, the network device determines (e.g., the leaf switch 116 determines, the leaf switch 700 determines, the packet processor 720 determines, the forwarding engine 724 determines, the path selection engine 760 determines, etc.) a set of multiple direct links for transmitting the packet. In an embodiment, determining the set of multiple direct links at block 808 comprises the forwarding engine 724 performing a lookup in a forwarding database using header information of the packet. In an embodiment, blocks 804 and 808 correspond to the forwarding engine 724 performing a lookup in a forwarding database using header information (including the tag) of the packet.

At block 812, the network device selects (e.g., the leaf switch 116 selects, the leaf switch 700 selects, the packet processor 720 selects, the path selection engine 760 selects, etc.) one of the direct links in the set of multiple direct links for transmitting the packet. Examples techniques for performing the selection at block 812 are described below. Performing the selection at block 812 sometimes results in a link being selected for the packet even when another link is exhibiting a better quality level, in some embodiments. In an embodiment, performing the selection at block 812 comprises probabilistically selecting the direct link according to a probability function that favors selecting links with a higher quality over links with lower quality. In an embodiment, probabilistically selecting the direct link, as discussed above, results in selecting a link with higher quality in most instances, but sometimes selecting a link with lower quality.

On the other hand, in response to determining at block 804 that the packet is to be transmitted via an indirect link, the flow proceeds to block 820.

At block 820, the network device determines (e.g., the leaf switch 116 determines, the leaf switch 700 determines, the packet processor 720 determines, the forwarding engine 724 determines, the path selection engine 760 determines, etc.) a set of multiple indirect links for transmitting the packet. In an embodiment, determining the set of multiple indirect links at block 820 comprises the forwarding engine 724 performing a lookup in the forwarding database using header information of the packet. In an embodiment, blocks 804 and 820 correspond to the forwarding engine 724 performing a lookup in a forwarding database using header information (including the tag) of the packet.

At block 824, the network device selects (e.g., the leaf switch 116 selects, the leaf switch 700 selects, the packet processor 720 selects, the path selection engine 760 selects, etc.) one of the indirect links in the set of multiple indirect links for transmitting the packet. Examples techniques for performing the selection at block 824 are described below. Performing the selection at block 824 sometimes results in a link being selected for the packet even when another link is exhibiting a better quality level, in some embodiments. In an embodiment, performing the selection at block 824 comprises probabilistically selecting the indirect link according to a probability distribution function that favors selecting links with a higher quality over links with lower quality. In an embodiment, probabilistically selecting the indirect link, as discussed above, results in selecting a link with higher quality in most instances, but sometimes selecting a link with lower quality.

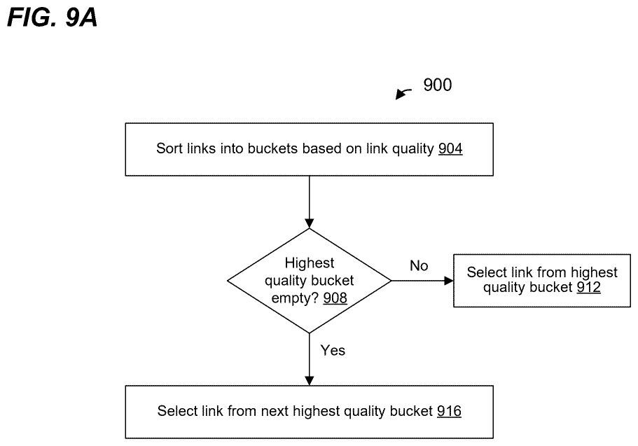

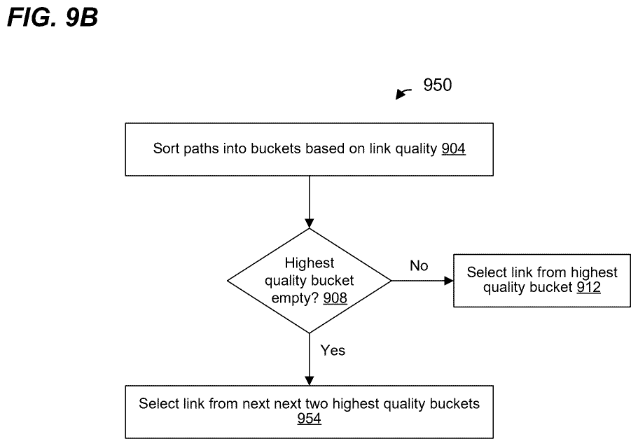

FIG. 9A is a flow diagram of an example method 900 for selecting a link in a network switching system for transmitting a packet, according to an embodiment. The method 900 is performed by a network device such as the leaf switch 116 and/or the leaf switch 700, and the method 900 is described with reference to FIGS. 1A-C, and 7 for explanatory purposes. In other embodiments, the method 900 is performed by another suitable network device. In some embodiments, the leaf switch 116 and/or the leaf switch 700 perform another suitable method for selecting a link a network switching system different than the method 900.

At block 904, the network device sorts (e.g., the leaf switch 116 sorts, the leaf switch 700 sorts, the packet processor 700 sorts, the path selection engine 760 sorts, etc.) into a plurality of buckets link indicators for respective links from a set of links (e.g., a set of direct links, a set of indirect links, etc.) based on quality information (e.g., LQMs) for the links. Respective buckets correspond to respective levels of quality.

In an illustrative embodiment that includes four buckets, the buckets correspond to the following levels of quality: i)very high, ii) high, iii) moderate, and iv) low. In other embodiments with four buckets, the buckets correspond to other suitable levels of quality. In other embodiments, suitable numbers of buckets other than four are utilized. In some embodiments in which the link quality information comprises LQMs, respective buckets correspond to respective ranges of LQM values. In various embodiments, the ranges have a same width or two or more different widths.

At block 908, the network device determines (e.g., the leaf switch 116 determines, the leaf switch 700 determines, the packet processor 700 determines, the path selection engine 760 determines, etc.) whether a highest quality bucket (i.e., a bucket corresponding to a highest quality level) is empty. If the network device determines (e.g., the leaf switch 116 determines, the leaf switch 700 determines, the packet processor 700 determines, the path selection engine 760 determines, etc.) that the highest quality bucket is not empty, the flow proceeds to block 912. At block 912, the network device (e.g., the leaf switch 116, the leaf switch 700, the packet processor 700, the path selection engine 760, etc.) selects a link that corresponds to link quality information sorted into the highest quality bucket. If the highest quality bucket includes more than one link, selecting the link at block 412 comprises selecting the link randomly (e.g., pseudorandomly), according to an embodiment. In other embodiments, the link is selected at block 912 using another suitable technique when the highest quality bucket includes more than one link.

On the other hand, if the network device determines (e.g., the leaf switch 116 determines, the leaf switch 700 determines, the packet processor 700 determines, the path selection engine 760 determines, etc.) at block 908 that the highest quality bucket is empty, the flow proceeds to block 916. At block 916, the network device selects (e.g., the leaf switch 116 selects, the leaf switch 700 selects, the packet processor 700 selects, the path selection engine 760 selects, etc.) a link sorted into a bucket that corresponds to a next highest quality as compared to the highest quality bucket. If the next highest quality bucket includes more than one link, selecting the link at block 916 comprises selecting the link randomly (e.g., pseudorandomly), according to an embodiment. In other embodiments, the link is selected at block 916 using another suitable technique when the next highest quality bucket includes more than one link.

FIG. 9B is a flow diagram of another example method 950 for selecting a link in a network switching system for transmitting a packet, according to an embodiment. The method 950 is performed by a network device such as the leaf switch 16 and/or the leaf switch 700, and the method 950 is described with reference to FIGS. 1A-C, and 7 for explanatory purposes. In other embodiments, the method 950 is performed by another suitable network device. In some embodiments, the leaf switch 116 and/or the leaf switch 700 perform another suitable method for selecting a link in a network switching system different than the method 950.

The method 950 is similar to the method 900 of FIG. 9A, and like-numbered elements are not discussed again in detail for brevity.

If the network device determines (e.g., the leaf switch 116 determines, the leaf switch 700 determines, the packet processor 700 determines, the path selection engine 760 determines, etc.) at block 908 that the highest quality bucket is empty, the flow proceeds to block 954. At block 954, the network device selects (e.g., the leaf switch 116 selects, the leaf switch 700 selects, the packet processor 700 selects, the path selection engine 760 selects, etc.) a link from a set of links sorted into two buckets that corresponds to two next highest qualities as compared to the highest quality bucket, i.e., a second highest quality bucket and a third highest quality bucket.

If the second and third highest quality buckets include more than one link, selecting the link at block 954 comprises selecting the link randomly (e.g., pseudorandomly), according to an embodiment. In another embodiment, selecting the link at block 954 comprises probabilistically selecting the link from the second highest quality bucket with a probability Y, and selecting the link from the third highest quality bucket with a probability Y-1, according to another embodiment. In an embodiment, Y is chosen to favor selection from the second highest quality bucket, at least in some situations. In other embodiments, Y is chosen in another suitable manner.

Selecting the link in the manner of block 954 results in the link sometimes being selected from the third highest quality bucket rather than the second highest quality bucket, which provides advantages such as described above.

In other embodiments, the link is selected at block 954 using another suitable technique when the second and third highest quality buckets include more than one link.

As discussed above with reference to FIGS. 2 and 7, the link selection engine 260/760 is configured to make a path selection decision for a packet in a packet flow or flowlet, and then use the same decision for at least some subsequent packets in the packet flow or flowlet, according to some embodiments. For example, the link selection engine 260/760 uses the same decision for subsequent packets in the packet flow or flowlet until an ending condition, such as a time period since a previous packet in the flow/flowlet was received exceeds a threshold, in some embodiments. In some embodiments, the link selection engine 260/760 is configured to sometimes select a new path for a packet in the flow/flowlet even when the ending condition has not yet occurred. For example, the link selection engine 260/760 is configured to probabilistically determine whether to select a new path for a packet in the flow/flowlet prior to the ending condition occurring such that sometimes a new path is not selected (i.e., the same current path for the flow/flowlet should be used) and sometimes a new path is selected for packets in the flow/flowlet).

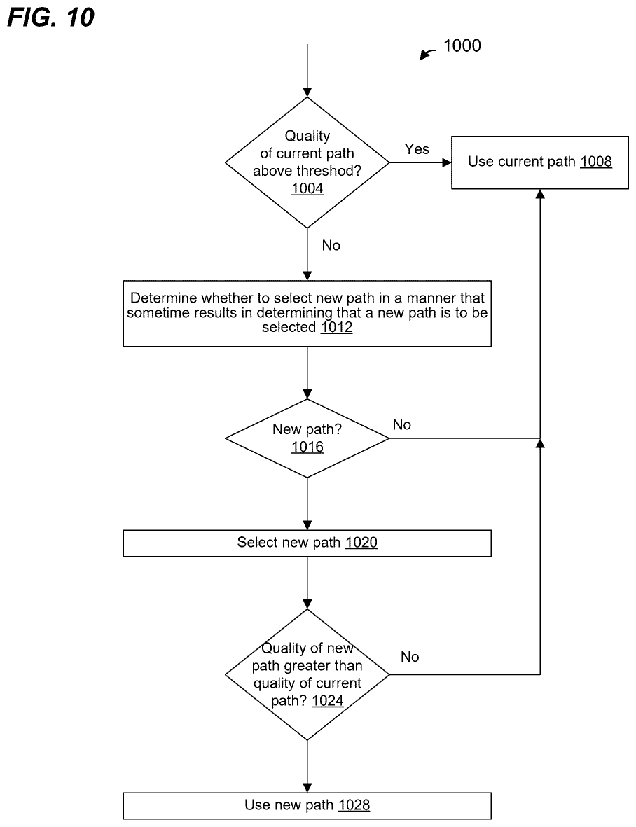

FIG. 10 is a flow diagram of an example method 1000 for selecting a path and/or link through a network switching system for a packet that belongs to a flow or flowlet for which a path/link was previously selected, according to an embodiment. The method 1000 is performed by a network device such as the TOR switch 108, the TOR switch 200, the leaf switch 116, and/or the leaf switch 700, in various embodiments, and the method 1000 is described with reference to FIGS. 2 and 7 for explanatory purposes. In other embodiments, the method 1000 is performed by another suitable network device. In some embodiments, the TOR switch 108, the TOR switch 200, the leaf switch 116, and/or the leaf switch 700 do not perform the method 1000. In some embodiments, the TOR switch 108, the TOR switch 200, the leaf switch 116, and/or the leaf switch 700 perform another suitable method for selecting a path/link through a network switching system for a packet that belongs to a flow or flowlet for which a path/link was previously selected different than the method 1000.

At block 1004, the network device determines (e.g., the TOR switch 108 determines, the TOR switch 200 determines, the packet processor 220 determines, the path selection engine 260 determines, the leaf switch 116 determines, the leaf switch 700 determines, the packet processor 720 determines, the link selection engine 760 determines, etc.) whether a quality metric (e.g., a PQM, LQM, etc.) for the current path/link (i.e., the path/link that was previously selected for packets in the flow/flowlet) is above a threshold. In an embodiment, the current path/link for a packet is determined by the path/link selection engine 260/760 by retrieving an indicator of the current path/link from the memory 272.

In response to the network device determining at block 1004 that the quality metric is above the threshold, the flow proceeds to block 1008. At block 1008, the network device uses (e.g., the TOR switch 108 uses, the TOR switch 200 uses, the packet processor 220 uses, the path selection engine 260 uses, the leaf switch 116 uses, the leaf switch 700 uses, the packet processor 720 uses, the link selection engine 760 uses, etc.) the current path/link (i.e., the path/link that was previously selected for packets in the flow/flowlet) for transmitting the packet.

On the other hand, in response to the network device determining at block 1004 that the quality metric is below the threshold, the flow proceeds to block 1012. At block 1012, the network device determines (e.g., the TOR switch 108 determines, the TOR switch 200 determines, the packet processor 220 determines, the path selection engine 260 determines, the leaf switch 116 determines, the leaf switch 700 determines, the packet processor 720 determines, the link selection engine 760 determines, etc.) whether a new path/link is to be selected for packets in the flow/flowlet in a manner that sometime results in determining that the current path/link should be used (i.e., a new path/link should not be used) and sometime results in determining that a new path/link is to be selected.

In an embodiment, selecting whether a new path/link is to be selected at block 1012 comprise probabilistically selecting between one of i) determining that the current path/link should be used (i.e., a new path/link should not be used), and ii) determining that a new path/link is to be selected. In an embodiment, the probability distribution function varies depending on a quality level (e.g., a PQM, an LQM, etc.) of the current path/link. In an embodiment, the probability function varies over time.

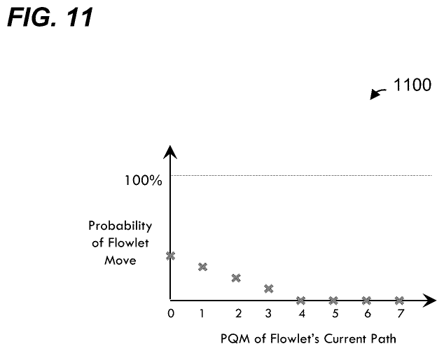

FIG. 11 is a plot of an example probability function 1100 used by a network device (e.g., the TOR switch 108, the TOR switch 200, the leaf switch 700, etc.) to probabilistically select between one of i) determining that the current path/link should be used (i.e., a new path/link should not be used), and ii) determining that a new path/link is to be selected, according to an embodiment. For example, the path/link selection engine 260/760 uses the probability distribution function 1100 to select between one of i) determining that the current path/link should be used (i.e., a new path/link should not be used), and ii) determining that a new path/link is to be selected, according to an embodiment. One or more probability functions like the probability distribution function 1100 are stored in the memory 264, in an embodiment.

The probability function 1100 corresponds to PQMs that have eight levels, where increasing values of the PQM correspond to increasing levels of quality. For example, a PQM of zero indicates very low quality, whereas a PQM of seven indicates very high quality.

The probability distribution function 1100 corresponds to a PQM of a path currently selected for a flow/flowlet. As can be seen in FIG. 11, when the PQM of the currently selected path is four or more, the network device will continue using the currently selected path (i.e., the probability of choosing to select a new path is 0%). As PQM decreases below four, the chance of selecting a new path increases. For instance, when PQM is three, the probability of selecting a new path is about 5%; when PQM is two, the probability of selecting a new path is about 15%; when PQM is one, the probability of selecting a new path is about 25%; and when PQM is zero, the probability of selecting a new path is about 35%.

Referring again to FIG. 10, in another embodiment, selecting whether a new path/link is to be selected at block 1012 comprise deterministically selecting between one of i) determining that the current path/link should be used (i.e., a new path/link should not be used), and ii) determining that a new path/link is to be selected according to path selection configuration information stored in the configuration memory 264, where the path selection configuration information determines how often it is determined at block 1012 that a new path is to be selected. As an illustrative example, selection at block 1012 is determined (e.g., in a round robin manner, according to a deterministic pattern, etc.) such that the it is mostly determined that the current path should be used but sometimes determined that a new path is to be selected according to the path selection configuration information.

In response to the network device determining at block 1012 that the current path/link should be used (i.e., a new path/link should not be used), the flow proceeds to block 1008, where the network device uses the current path/link (i.e., the path/link that was previously selected for packets in the flow/flowlet) for transmitting the packet.

On the other hand, in response to the network device determining at block 1012 that a new path/link is to be selected for packets in the flow/flowlet, the flow proceeds to block 1020. At block 1020, the network device selects (e.g., the TOR switch 108 selects, the TOR switch 200 selects, the packet processor 220 selects, the path selection engine 260 selects, the leaf switch 116 selects, the leaf switch 700 selects, the packet processor 720 selects, the link selection engine 760 selects, etc.) a new path/link. For example, a new path/link is selected in a manner the same as or similar to one or more techniques described above with reference to FIGS. 4A-B, 8, and/or 9A-B, according to various embodiment. A new path/link is selected at block 1020 additionally or alternatively in a manner the same as or similar to techniques described above with reference to FIG. 3, according to another embodiment.

At block 1024, the network device determines (e.g., the TOR switch 108 determines, the TOR switch 200 determines, the packet processor 220 determines, the path selection engine 260 determines, the leaf switch 116 determines, the leaf switch 700 determines, the packet processor 720 determines, the link selection engine 760 determines, etc.) whether a quality metric of the new path/link selected at block 1020 indicates higher quality as compared to a quality metric of the current path/link. For example, the network device determines whether the PQM/LQM of the new path/link is greater than a PQM/LQM of the current path/link.

In response to determining at block 1024 that the quality metric of the new path/link selected at block 1020 indicates lower quality as compared to the quality metric of the current path/link, the flow proceeds to block 1008, where the network device uses the current path/link (i.e., the path/link that was previously selected for packets in the flow/flowlet) for transmitting the packet.

On the other hand, in response to determining at block 1024 that the quality metric of the new path/link selected at block 1020 indicates higher quality as compared to the congestion metric of the current path/link, the flow proceeds to block 1028. At block 1028, the network device uses (e.g., the TOR switch 108 uses, the TOR switch 200 uses, the packet processor 220 uses, the leaf switch 116 uses, the leaf switch 700 uses, the packet processor 720 uses, etc.) the path/link selected at block 1020 for transmitting the packet. In an embodiment, the method further comprises storing an indication of the new path (selected at block 1020) in association with the flow/flowlet in a memory (e.g., the memory 272) so that when a subsequent packet in the packet flow/flowlet is received, the network device is configured to lookup, in the memory, the path decision previously made (at block 1020) for the packet flow/flowlet to which the packet belongs.

In some embodiments, a network device (e.g., the TOR switch 108, the TOR switch 200, the leaf switch 116, the leaf switch 700, etc.) that implement techniques such as described above is configurable to disable use of these techniques for some or all packets processed by the network device. For example, the network device is configured to identify (e.g., the TOR switch 108 identifies, the TOR switch 200 identifies, the packet processor 220 identifies, the path selection engine 260 identifies, the leaf switch 116 identifies, the leaf switch 700 identifies, the packet processor 720 identifies, the link selection engine 760 identifies, etc.) packets and/or packet flows that are sensitive to re-ordering (e.g., using one or more of protocol information, quality of service information, etc., in headers of packets of the flows), and to disable use of techniques such as described herein for the identified packets and/or packets in the identified flows. For instance, the network device is configured to use one or more other suitable techniques (including conventional techniques) for determining paths through the network switching system are used for such packets.

In some embodiments, access control lists (ACLs) indicate whether techniques such as described herein are to be used for certain packets/flows, ports, etc., and the network device uses (e.g., the TOR switch 108 uses, the TOR switch 200 uses, the packet processor 220 uses, the path selection engine 260 uses, the leaf switch 116 uses, the leaf switch 700 uses, the packet processor 720 uses, the link selection engine 760 uses, etc.) the ACLs to determine whether to use techniques such as described herein (or whether to use one or more other suitable techniques) for selecting paths through the network switching system for particular packets.

Embodiment 1: A network device that selects paths through a network switching system, the network device comprising: a packet processor configured to: determine a set of one or more first paths through the network switching system for forwarding a packet to a second network device in the network switching system, including determining the set of one or more first paths from amongst minimal paths through the network switching system, and determine a set of one or more second paths through the network switching system for forwarding the packet to the second network device, including determining the set of one or more second paths from amongst non-minimal paths through the network switching system. The packet processor includes a path selection engine configure to select one of i) the set of one or more first paths, and ii) the set of one or more second paths for forwarding the packet through the network switching system, including sometimes selecting the set of one or more second paths for forwarding the packet through the network switching system.

Embodiment 2: The network device of embodiment 1, wherein the path selection engine is configured to: probabilistically select the one of i) the set of one or more first paths, and ii) the set of one or more second paths according to a probability.

Embodiment 3: The network device of embodiment 2, wherein the path selection engine is configured to: probabilistically select the one of i) the set of one or more first paths, and ii) the set of one or more second paths according to a probability that favors selecting the set of one or more first paths.

Embodiment 4: The network device of either of embodiments 2 or 3, wherein the path selection engine is configured to: probabilistically select the one of i) the set of one or more first paths, and ii) the set of one or more second paths according to a probability that varies according to one or more quality metrics corresponding to the set of one or more first paths determined by the first network device.

Embodiment 5: The network device of any of embodiments 2-4, wherein the path selection engine is configured to: probabilistically select the one of i) the set of one or more first paths, and ii) the set of one or more second paths according to a probability that varies over time.

Embodiment 6: The network device of any of embodiments 1-5, wherein the packet processor is configured to: determine the set of one or more first paths from amongst a first set of multiple paths having a first length through the network switching system to the second network device, the first length corresponding to a number of hops through the network switching system; and determine the set of one or more second paths from amongst a second set of multiple paths having one or more second lengths through the network switching system to the second network device, each of the one or more second lengths having more hops than the number of hops corresponding to the first length.

Embodiment 7: The network device of any of embodiments 1-6, wherein: the path selection engine is configured to select a first port of the first network device for forwarding the packet, the first port corresponding to the selecting of the one of i) the set of one or more first paths, and ii) the set of one or more second paths, the first port amongst a plurality of ports coupled to a plurality of other network devices in the network switching system, the first port coupled to a third network device amongst the other network devices in the network switching system; and the packet processor is configured to forward the packet to the third network device via the first port.

Embodiment 8: The network device of embodiment 7, wherein the packet processor includes: a header modification engine configured to mark the packet to indicate to the third network device the one of i) the set of one or more first paths, and ii) the set of one or more second paths selected by the first network device.

Embodiment 9: The network device of any of embodiments 1-8, further comprising: a path quality monitoring engine is configured to determine quality metrics corresponding to different paths through the network switching system. The packet processor is configured to: determine the set of one or more first paths through the network switching system based on quality metrics for a first group of minimal paths through the network switching system; and determine the set of one or more second paths through the network switching system based on quality metrics for a second group of non-minimal paths through the network switching system.

Embodiment 10: The network device of embodiment 9, wherein the packet processor is configured to determine the set of one or more second non-minimal paths based on quality metrics for a second group of non-minimal paths that includes no paths from the first group of minimal paths.

Embodiment 11: A method for selecting paths through a network switching system, the method comprising: determining, at a first network device, a set of one or more first paths through the network switching system for forwarding a packet to a second network device in the network switching system, including determining the set of one or more first paths from amongst minimal paths through the network switching system; determining, at the first network device, a set of one or more second paths through the network switching system for forwarding the packet to the second network device, including determining the set of one or more second paths from amongst non-minimal paths through the network switching system; and selecting, at the first network device, one of i) the set of one or more first paths, and ii) the set of one or more second paths for forwarding the packet through the network switching system, including sometimes selecting the set of one or more second paths for forwarding the packet through the network switching system.

Embodiment 12: The method for selecting paths of embodiment 11, wherein selecting the one of i) the set of one or more first paths, and ii) the set of one or more second paths comprises: probabilistically selecting the one of i) the set of one or more first paths, and ii) the set of one or more second paths according to a probability.

Embodiment 13: The method for selecting paths of embodiment 12, wherein probabilistically selecting the one of i) the set of one or more first paths, and ii) the set of one or more second paths according to the probability comprises: probabilistically selecting the one of i) the set of one or more first paths, and ii) the set of one or more second paths according to a probability that favors selecting the set of one or more first paths.

Embodiment 14: The method for selecting paths of either of embodiments 12 or 13, wherein probabilistically selecting the one of i) the set of one or more first paths, and ii) the set of one or more second paths according to the probability comprises: probabilistically selecting the one of i) the set of one or more first paths, and ii) the set of one or more second paths according to a probability that varies according to one or more quality metrics corresponding to the set of one or more first paths determined by the first network device.

Embodiment 15: The method for selecting paths of any of embodiments 12-14, wherein probabilistically selecting the one of i) the set of one or more first paths, and ii) the set of one or more second paths according to the probability comprises: probabilistically selecting the one of i) the set of one or more first paths, and ii) the set of one or more second paths according to a probability that varies over time.

Embodiment 16: The method for selecting paths of any of embodiments 11-15, wherein: determining the set of one or more first paths comprises determining the set of one or more first paths from amongst a first set of multiple paths having a first length through the network switching system to the second network device, the first length corresponding to a number of hops through the network switching system; determining the set of one or more second paths comprises determining the set of one or more second paths from amongst a second set of multiple paths having one or more second lengths through the network switching system to the second network device, each of the one or more second lengths having more hops than the number of hops corresponding to the first length.

Embodiment 17: The method for selecting paths of any of embodiments 11-16, further comprising: selecting, at the first network device, a first port of the first network device for forwarding the packet, the first port corresponding to the selecting of the one of i) the set of one or more first paths, and ii) the set of one or more second paths, the first port amongst a plurality of ports coupled to a plurality of other network devices in the network switching system, the first port coupled to a third network device amongst the other network devices in the network switching system; and forwarding, by the first network device, the packet to the third network device via the first port.

Embodiment 18: The method for selecting paths of embodiment 17, further comprising: marking, at the first network device, the packet to indicate to the third network device the one of i) the set of one or more first paths, and ii) the set of one or more second paths selected by the first network device.

Embodiment 19: The method for selecting paths of any of embodiments 11-18, further comprising: determining, at the first network device, quality metrics corresponding to different paths through the network switching system; determining, at the first network device, the set of one or more first paths through the network switching system based on quality metrics for a first group of minimal paths through the network switching system; and determining, at the first network device, the set of one or more second paths through the network switching system based on quality metrics for a second group of non-minimal paths through the network switching system.

Embodiment 20: The method for selecting paths of embodiment 19, wherein determining the set of one or more second paths based on quality metrics for the second group of non-minimal paths comprises determining the set of one or more second paths based on quality metrics for a second group of non-minimal paths that includes no paths from the first group of minimal paths.

Some of the various blocks, operations, and techniques described above may be implemented utilizing hardware, a processor executing firmware instructions, a processor executing software instructions, or any suitable combination thereof. When implemented utilizing a processor executing software or firmware instructions, the software or firmware instructions may be stored in any suitable computer readable memory. The software or firmware instructions may include machine readable instructions that, when executed by one or more processors, cause the one or more processors to perform various acts such as described above.

When implemented in hardware, the hardware may comprise one or more of discrete components, an integrated circuit, an application-specific integrated circuit (ASIC), a programmable logic device (PLD), etc.

While the present invention has been described with reference to specific examples, which are intended to be illustrative only and not to be limiting of the invention, changes, additions and/or deletions may be made to the disclosed embodiments without departing from the scope of the invention.

1. A network device that selects paths through a network switching system, the network device comprising:
a packet processor configured to:
determine a set of one or more first paths through the network switching system for forwarding a packet to a second network device in the network switching system, including determining the set of one or more first paths from amongst minimal paths through the network switching system, and
determine a set of one or more second paths through the network switching system for forwarding the packet to the second network device, including determining the set of one or more second paths from amongst non-minimal paths through the network switching system; and
wherein the packet processor includes a path selection engine configure to probabilistically select according to a probability, one of i) the set of one or more first paths, and ii) the set of one or more second paths for forwarding the packet through the network switching system, including sometimes selecting the set of one or more second paths for forwarding the packet through the network switching system.

2. (canceled)

3. The network device of claim 1, wherein the path selection engine is configured to:
probabilistically select the one of i) the set of one or more first paths, and ii) the set of one or more second paths according to a probability that favors selecting the set of one or more first paths.

4. The network device of claim 1, wherein the path selection engine is configured to:
probabilistically select the one of i) the set of one or more first paths, and ii) the set of one or more second paths according to a probability that varies according to one or more quality metrics corresponding to the set of one or more first paths determined by the first network device.

5. The network device of claim 1, wherein the path selection engine is configured to:
probabilistically select the one of i) the set of one or more first paths, and ii) the set of one or more second paths according to a probability that varies over time.

6. The network device of claim 1, wherein the packet processor is configured to:
determine the set of one or more first paths from amongst a first set of multiple paths having a first length through the network switching system to the second network device, the first length corresponding to a number of hops through the network switching system; and
determine the set of one or more second paths from amongst a second set of multiple paths having one or more second lengths through the network switching system to the second network device, each of the one or more second lengths having more hops than the number of hops corresponding to the first length.

7. The network device of claim 1, wherein:
the path selection engine is configured to select a first port of the first network device for forwarding the packet, the first port corresponding to the selecting of the one of i) the set of one or more first paths, and ii) the set of one or more second paths, the first port amongst a plurality of ports coupled to a plurality of other network devices in the network switching system, the first port coupled to a third network device amongst the other network devices in the network switching system; and
the packet processor is configured to forward the packet to the third network device via the first port.

8. The network device of claim 7, wherein the packet processor includes:
a header modification engine configured to mark the packet to indicate to the third network device the one of i) the set of one or more first paths, and ii) the set of one or more second paths selected by the first network device.

9. The network device of claim 1, further comprising:
a path quality monitoring engine is configured to determine quality metrics corresponding to different paths through the network switching system;
wherein the packet processor is configured to:
determine the set of one or more first paths through the network switching system based on quality metrics for a first group of minimal paths through the network switching system, and
determine the set of one or more second paths through the network switching system based on quality metrics for a second group of non-minimal paths through the network switching system.

10. The network device of claim 9, wherein the packet processor is configured to determine the set of one or more second non-minimal paths based on quality metrics for a second group of non-minimal paths that includes no paths from the first group of minimal paths.

11. A method for selecting paths through a network switching system, the method comprising:
determining, at a first network device, a set of one or more first paths through the network switching system for forwarding a packet to a second network device in the network switching system, including determining the set of one or more first paths from amongst minimal paths through the network switching system;
determining, at the first network device, a set of one or more second paths through the network switching system for forwarding the packet to the second network device, including determining the set of one or more second paths from amongst non-minimal paths through the network switching system; and
probabilistically selecting, at the first network device according to a probability, one of i) the set of one or more first paths, and ii) the set of one or more second paths for forwarding the packet through the network switching system, including sometimes selecting the set of one or more second paths for forwarding the packet through the network switching system.

12. (canceled)

13. The method for selecting paths of claim 11, wherein probabilistically selecting the one of i) the set of one or more first paths, and ii) the set of one or more second paths according to the probability comprises:
probabilistically selecting the one of i) the set of one or more first paths, and ii) the set of one or more second paths according to a probability that favors selecting the set of one or more first paths.

14. The method for selecting paths of claim 11, wherein probabilistically selecting the one of i) the set of one or more first paths, and ii) the set of one or more second paths according to the probability comprises:
probabilistically selecting the one of i) the set of one or more first paths, and ii) the set of one or more second paths according to a probability that varies according to one or more quality metrics corresponding to the set of one or more first paths determined by the first network device.

15. The method for selecting paths of claim 11, wherein probabilistically selecting the one of i) the set of one or more first paths, and ii) the set of one or more second paths according to the probability comprises:
probabilistically selecting the one of i) the set of one or more first paths, and ii) the set of one or more second paths according to a probability that varies over time.

16. The method for selecting paths of claim 11, wherein:
determining the set of one or more first paths comprises determining the set of one or more first paths from amongst a first set of multiple paths having a first length through the network switching system to the second network device, the first length corresponding to a number of hops through the network switching system;
determining the set of one or more second paths comprises determining the set of one or more second paths from amongst a second set of multiple paths having one or more second lengths through the network switching system to the second network device, each of the one or more second lengths having more hops than the number of hops corresponding to the first length.

17. The method for selecting paths of claim 11, further comprising:
selecting, at the first network device, a first port of the first network device for forwarding the packet, the first port corresponding to the selecting of the one of i) the set of one or more first paths, and ii) the set of one or more second paths, the first port amongst a plurality of ports coupled to a plurality of other network devices in the network switching system, the first port coupled to a third network device amongst the other network devices in the network switching system; and
forwarding, by the first network device, the packet to the third network device via the first port.

18. The method for selecting paths of claim 17, further comprising:
marking, at the first network device, the packet to indicate to the third network device the one of i) the set of one or more first paths, and ii) the set of one or more second paths selected by the first network device.

19. The method for selecting paths of claim 11, further comprising:
determining, at the first network device, quality metrics corresponding to different paths through the network switching system;
determining, at the first network device, the set of one or more first paths through the network switching system based on quality metrics for a first group of minimal paths through the network switching system; and
determining, at the first network device, the set of one or more second paths through the network switching system based on quality metrics for a second group of non-minimal paths through the network switching system.

20. The method for selecting paths of claim 19, wherein determining the set of one or more second paths based on quality metrics for the second group of non-minimal paths comprises determining the set of one or more second paths based on quality metrics for a second group of non-minimal paths that includes no paths from the first group of minimal paths.
